(19) United States
(12) Patent Application Publication
(10) Pub. No.: US 2018/0134357 A1
(43) Pub. Date: May 17, 2018

(54) KITE-POWERED UNMANNED UNDERWATER VEHICLE

(71) Applicant: SRI INTERNATIONAL, MENLO PARK, CA (US)

(72) Inventors: MICHAEL VESTEL, SAN FRANCISCO, CA (US); STAN PLESKUNAS, WATSONVILLE, CA (US); JOHN WATERSTON, VIENNA, VA (US)

(21) Appl. No.: 15/572,041

(22) PCT Filed: May 9, 2016
(86) PCT No.: PCT/US2016/031527

§ 371 Date: Nov. 6, 2017

Related U.S. Application Data
(60) Provisional application No. 62/158,454, filed on May 7, 2015.

(51) Int. Cl. B63H 9/06; B63G 8/18; B63G 8/00; B63G 8/42; B64C 31/06

(52) U.S. Cl. CPC B63H 9/0685; B63G 8/18; B63B 2035/009; B63G 8/42; B64C 31/06; B63G 8/001

(57) ABSTRACT

A wind-powered unmanned underwater vehicle (UUV) system can include a kite subsystem configured to be powered by wind energy, a control pod coupled with the kite sub-system and configured to control the kite sub-system, a payload platform configured to provide a mechanical structure on which at least one module may be mounted, a submersible UUV, and a coupling device configured to physically couple between the kite sub-system and the submersible UUV.

### CROSS-REFERENCE TO RELATED APPLICATION

This application claims the benefit of U.S. Provisional Patent Application Ser. No. 62/158,454, titled WIND POWERED AUTONOMOUS VEHICULAR SYSTEM and filed on May 7, 2015, the content of which is hereby incorporated by reference herein in its entirety.

### GOVERNMENT FUNDING

This application was made with Government support under contract numbers D14PC00184 and D13PC00192 awarded by the Department of Interior. The Government has certain rights in this invention.

### BACKGROUND

There are various areas in which multiple needs must be addressed. For example, in the area of national security, there is a need for communications in a communications-deprived maritime environment. A communications-deprived environment may occur if, for example, a communications satellite fails. A ship or a group of ships may suddenly find itself vulnerable to threats within the surrounding area, depending on the failed satellite for situational awareness. In such situations, having at least some organic reconnaissance capability would be of significant advantage.

Another need arises in situations where there is a requirement to know the local conditions in the vicinity of a ship or group of ships more accurately than can be assessed by remote sensors. Conditions such as water temperature, wave conditions, presence of other friendly or non-friendly assets, and presence of bodies such as icebergs, for example, may be critical in carrying out a mission.

Yet another need arises in situations where flexible and configurable relay stations are needed to communicate information over large distances, e.g., in the absence of a central communications infrastructure. In an exemplary situation in which such a need may be experienced, only one vessel or a few vessels in a group of vessels can communicate with a satellite but all of the vessels need the information. Thus, the need in such a situation is the ability to communicate the information from one vessel to at least one of the other vessels using a local network.

Other areas having needs to be addresses include off-shore and/or on-shore energy harvesting, various types of search and rescue missions, e.g., on water, and certain weather-related activities.

### BRIEF DESCRIPTION OF THE DRAWINGS

FIG. 1 is a block diagram illustrating an example of a kite-powered unmanned underwater vehicle (UUV) in accordance with certain embodiments of the disclosed technology.

FIG. 2A illustrates an isometric view of a first embodiment of a kite sub-system in accordance with the disclosed technology.

FIG. 2B illustrates a front view of the first embodiment of a kite sub-system.

FIG. 2C illustrates a back view of the first embodiment of a kite sub-system.

FIG. 2D illustrates a top view of the first embodiment of a kite sub-system.

FIG. 2E illustrates a side view of the first embodiment of a kite sub-system.

FIG. 2F illustrates a cross-sectional view of the pontoon portion of the first embodiment of a kite sub-system in accordance with the disclosed technology.

FIG. 3A illustrates an isometric view of a kite portion of a second embodiment of a kite sub-system in accordance with the disclosed technology.

FIG. 3B illustrates a front view of the kite portion of the second embodiment of a kite sub-system.

FIG. 3C illustrates a side view of the kite portion of the second embodiment of a kite sub-system.

FIG. 3D illustrates a partially exploded view exposing the internal structure of the kite portion of the second embodiment of a kite sub-system in accordance with the disclosed technology.

FIG. 4 illustrates an exemplary configuration of a kite sub-system that does not have a spar in accordance with the disclosed technology.

FIG. 5 illustrates an example of a rib such as the ribs in the embodiment illustrated by FIGS. 3A-D and the ribs in the configuration illustrated by FIG. 4.

FIG. 6A illustrates a top view of a first embodiment of a kite having bladders in accordance with the disclosed technology.

FIG. 6B illustrates an isometric view of the first embodiment of a kite having bladders.

FIG. 6C illustrates a cross-sectional view of the first embodiment of a kite having bladders.

FIG. 7A illustrates a first view of a second embodiment of a kite having bladders in accordance with the disclosed technology.

FIG. 7A illustrates a second view of the second embodiment of a kite having bladders.

FIG. 8 illustrates a first stage of the collapse of a bladder and intake of ambient air in accordance with certain embodiments of the disclosed technology.

FIG. 9 illustrates a second stage of the collapse of the bladder and intake of ambient air.

FIG. 10 illustrates a third stage of the collapse of the bladder and intake of ambient air.

FIG. 11A illustrates a section of an exemplary kite sub-system having bridle strings and a control pod in accordance with the disclosed technology.

FIG. 11B illustrates a cross-sectional view of the control pod of the exemplary kite sub-system.

FIG. 11C illustrates the use of twisted strings for use as bridle strings in the exemplary kite sub-system.

FIG. 12 illustrates an example of a payload platform in accordance with the disclosed technology.

FIG. 13A illustrates an isometric view of an exemplary submerged unmanned underwater vehicle (UUV) in accordance with the disclosed technology.

FIG. 13B illustrates a front view of the exemplary submerged UUV.

FIG. 13C illustrates a side view of the exemplary submerged UUV.

FIG. 13D illustrates a top view of the exemplary submerged UUV.

FIG. 13E illustrates a top view of a mast showing profile.

FIG. 13F illustrates the various axes of the exemplary submerged UUV.

FIG. 13G illustrates the center of mass and center of lift of the exemplary submerged UUV.

FIG. 13H illustrates an example of a conduit running through the mast as well as a tether that is routed through the conduit.

FIG. 13I illustrates the angle of incidence and angle of attack of the wing and the UUV.

FIG. 14A illustrates an example of the wing support structure to which the wings and the mast may be coupled.

FIG. 14B illustrates an example of the capability to adjust the angle of incidence of the wing and its longitudinal placement along the hull.

FIG. 15 illustrates an example of a towed body having hydrodynamic foils in accordance with certain embodiments of the disclosed technology.

FIG. 16 illustrates an example of a control system in accordance with certain embodiments of the disclosed technology.

FIG. 17 illustrates an example of an electrical sub-system in accordance with certain embodiments of the disclosed technology.

### DETAILED DESCRIPTION

Exemplary methods, devices, and systems in accordance with the disclosed technology, e.g., to establish a communications network, may be flexible, configurable, autonomous, unmanned, efficient from a power consumption standpoint, easily deployable in a maritime environment, cost-effective, and expandable. Such features will significantly improve the utility of such a communications network.

Implementations of the disclosed technology, generally referred to herein as “wind powered unmanned underwater vehicle (UUV),” “kite-powered UUV,” or simply “wind powered systems,” may include a single node or multiple nodes, each node consisting of a kite, such as the embodiment using a lighter-than-air (LTA) component, a submerged UUV, and a coupling device such as a tether configured to couple the kite to the UUV both mechanically and electrically. The kite may also be a simple downwind kite, or one that requires no kite control, or be a controllable kite that has no lighter than air feature. The kite component may have the capability of staying up in the air in virtually all wind conditions including having the capability of moving upwind, downwind, or simply remaining in the vicinity of a fixed point, e.g., station-keeping. Conceptually, such a system may be likened to a sail boat without a mast and where the sail is tethered or coupled to the hull, which is submerged in the water. The kite component may be designed to carry a payload such as communication equipment, cameras, and other sensors. In most wind conditions, including zero wind conditions when an LTA kite is employed, the payload may be aloft in the sky, thus enabling communications over a large area.

The UUV may contain the main power source, e.g., battery source, for the communications mechanism in addition to having mechanisms that steer and control the UUV's depth. The UUV may control the motion of the kite system along with the kite that harnesses wind energy to power the motion. Thus, in configurations where wind energy powers the motion of the UUV, it may not need to have onboard motors, or it may have onboard motors but not need to use them except during low wind circumstances Elimination of powered propulsion is an advantageous configuration as the size of the UUV may be kept small. In addition, if there are no motors or no motors are used when there are motors onboard propelling the UUV, the kite-powered UUV may travel silently, making it difficult to be detected while underwater, an advantage in operations requiring stealth such as looking for adversarial assets in the open ocean. In addition to the power source and the motion control mechanisms, the UUV may have its own array of sensors for sensing local conditions such as, but not limited to, water temperature, the presence of other objects in the vicinity, and water composition. In other configurations, the UUV may have systems onboard to generate power and/or recharge batteries by using, for example, a propeller housed in a ring-tail configuration and towed through the water to transform the kinetic energy of forward motion into electrical energy. The kite component may also contain power regeneration components, such as air-driven propellers moving generators, to recharge airborne payloads and batteries.

In certain implementations, the UUV may be partially submerged. In one advantageous configuration, the UUV may have a horizontal foil configured to stay below the surface of the water while heavy components stay above the water, similar to kite surfing foiling boards. In such an arrangement, the heavy and large components stored inside the UUV, if it were to be submerged, may be stored in a component above the water or below the water. When the kite pulls the UUV, the lift from the submerged foil raises the craft above the water. The heavy component comes off the water's surface while the foil remains below the surface. Reducing the volume of the underwater components generally reduces the drag in the water and increases speed significantly. Such an arrangement may be advantageous in situations where the UUV is required to transport large items, such as in transportation of goods, or situations where very high speeds, e.g., in excess of 45 mph are needed.

The ability of exemplary wind powered systems to be unmanned comes in large part from having sensors on or near the kite, in or above the UUV, and on the tether, and also having the ability to process the sensor data and react to it. The sensors and data processing and analysis capability, as well as the actuators that may react to the data, all form parts of a control system configured to ultimately control the behavior of the system. Thus, the UUV may also house a computer and other electronics hardware, which may form additional parts of the control system.

Although a single wind powered system may be useful by itself to provide data and intelligence, multiple wind powered systems may be launched and utilized simultaneously, thus extending the area of operation significantly. It will be appreciated that there is virtually no upper limit on the number of wind powered systems that may operate at the same time. The behavior of multiple systems can be coordinated, thereby increasing the effectiveness of such systems. As an example, the entire fleet of wind powered systems may be commanded to travel to a particular desired location while each individual system may be commanded to stay within a line of sight range with its neighbors.

There are a number of benefits provided by unmanned wind powered systems in accordance with the disclosed technology. Such systems may advantageously provide configurable, power-efficient, mobile, and expandable methods that may be used in various situations. As an example, such systems may be deployed to gather data and establish communications in a maritime environment. In certain such cases, the communications network established with the systems may be the only mode of communication between ships in a communication-deprived environment, such as when a satellite becomes unavailable. The kite may be configured to stay aloft and harness wind energy, e.g., to drive the motion of the kite and the UUV, thereby alleviating the need to lift a source of power such as batteries, which tend to be heavy. Some on-market systems are based on lifting heavy payloads such as batteries, which limit the utility of such systems. The issue of wind variability is addressed by deploying the kites at heights where winds are more stable. For example, depending on the implementation, the kites may be deployed from 25 ft to 2500 ft. An example study shows that at 300 meters (roughly 1000 feet) height, the minimum, average and maximum wind speeds for 2014 in the pacific were above 2.7 knots, 8.4 kn, and 15.1 kn, 95% of the time. As mentioned above, the UUV is generally tethered to the kite and submerged in the water. Additional benefits accrue due to this arrangement. For example, by having the UUV submerged in the water, the need to accommodate surface wave conditions may be obviated.

While certain embodiments described herein discuss the implementation of a kite or kite sub-system, it should be noted that other, alternative devices, components, and/or sub-systems may be implemented in place of a kite or kite sub-system. For example, a fixed wing assembly—or virtually any suitable device or component configured to be powered by the wind—may be used in place of a kite or kite sub-system.

In implementations of the disclosed technology, the design of the UUV generally becomes simpler and more cost effective. In addition, since the UUV is typically submerged in the water, it is able to achieve higher speeds. Typically, sail or wind powered vessels tend to be slow largely due to the use of surface displacement hull designs and the drag intensive appendages which create large amounts of wave and parasitic drag. Such issues may be avoided due to the submerged design of the disclosed embodiments. The tether, configured to couple the kite to the UUV, is generally the only element of the system that pierces the surface of the water. Such arrangements, especially when a low drag faring covers the underwater tether, vastly reduce the drag which, in typical systems, is a significant obstacle to high speed.

Other benefits may be realized due to the relatively small size of the UUV and, in certain configurations, the lack of on-board motors. Both of these factors typically improve the chances of the UUV being undetectable in that small objects are inherently harder to detect and the lack of on-board motors results in negligible or significantly reduced acoustic noise. Even further benefits may be realized by deploying multiple kite-powered systems because the presence of multiple kite-powered systems may greatly increase the operating range of the entire system. For example, a larger range usually improves the chances of obtaining an earlier warning, if such systems were to be utilized for an early warning system.

In addition to providing communications capabilities, regardless of whether one or multiple kite-powered UUV systems are utilized, the disclosed systems may provide accurate data about the local conditions such as wind speed, water temperature, etc. To the extent this data may be critical for mission success, the kite-powered UUV systems are generally able to provide this data continuously and for a range limited only by the number of kite-powered UUV systems that are aloft.

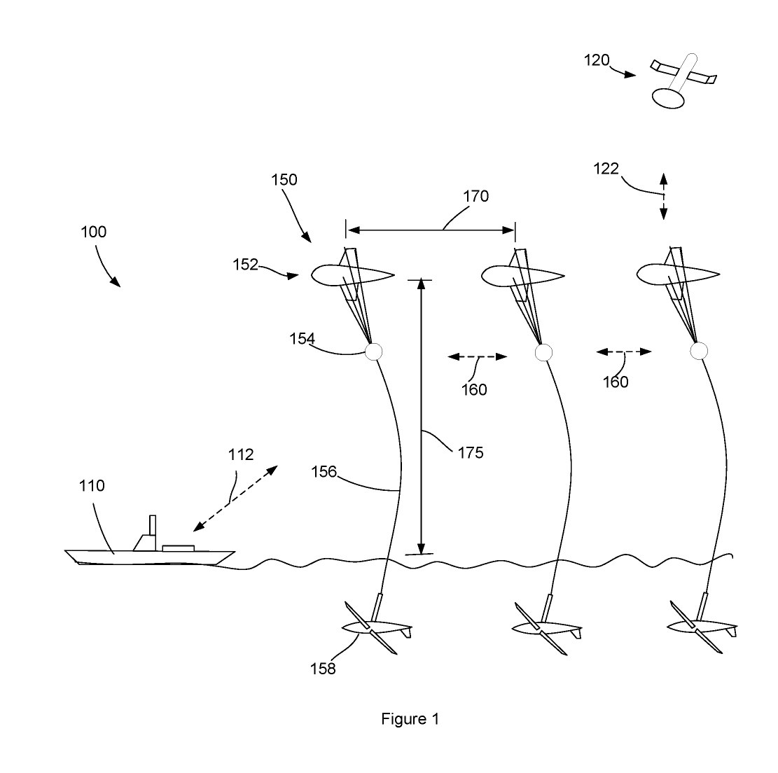

FIG. 1 is a block diagram illustrating an example 100 of a kite-powered UUV system 150 in accordance with certain embodiments of the disclosed technology. In the example 100, the kite-powered UUV system 150 includes a kite sub-system 152, a control pod and payload platform 154, a coupling mechanism 156, e.g., a tether, and a submerged UUV 158. In the example 100, the kite sub-system 152 is airborne and tethered to the submerged UUV 158. The airborne nature of the kite sub-system 152 is an advantageous property in that it enables the locating of communications equipment or a camera at heights that are suitable for increasing the range of communications and surveillance.

In the example 100, three wind powered UUV systems, including the wind powered UUV system 150, are illustrated. In certain implementations, however, there may be only a single such system or multiple such systems deployed at any one time. The example 100 also includes a ship 110 or other water-based vehicle or station in communication with the wind powered automated vehicular systems, as indicated by the bidirectional arrow 112. The wind powered UUV systems may have the ability to communicate with each other, e.g., as indicated by the bidirectional arrow 160. In addition to communicating with each other, the wind powered automated vehicular systems may also have the ability to communicate with a satellite 120, ship, ground station, or other aerial device or system, as indicated by the bidirectional arrow 122. Having communication equipment in the control pod and payload platform 154 advantageously enables these various communications capabilities.

The example 100 also shows that the wind powered systems may be separated by a certain distance 170. This distance may be variable and can be set either manually or automatically, e.g., determined by the systems themselves. In addition, although the illustrated example 100 depicts a linear arrangement of regularly spaced wind powered systems, it will be appreciated that virtually any spatial arrangement and/or spacing is possible, depending on the objectives of the deployment of such systems.

Although at the surface of the earth wind velocity varies greatly, at higher altitudes the wind velocity is generally more stable. For example, at 2,500 feet the wind speed is typically greater than 6 mph 99 percent of the time. The kite sub-system 152 may be advantageously designed so that it rises to a level, as indicated by reference number 175, where the wind velocity is more uniform and has less variance. For example, the kite sub-system 152 may be allowed to operate at a height of 500-2,500 feet. The steadier and stronger wind conditions at such altitude may thus be harnessed and subsequently power the motion of the entire wind powered UUV system 150. Due to the height at which the kite sub-system 152 may operate at as well as the lighter-than-air design, the kite sub-system 152 may be aloft 99 percent of the time when the winds are greater than 6 mph. The uptime of the kite sub-system 152 may translate directly to the uptime of the payload. If the kite sub-system 152 is reliably aloft, that typically translates to the reliability of the communications and data network in as much as these networks depend on being deployed at height.

As described above, the UUV 158 is completely submerged but tethered to the kite sub-system 152 by way of the coupling mechanism 156. The motion of the UUV 158 and, indeed, of the entire wind powered UUV system 150 is powered by the wind; however, the UUV 158 may have fins and/or a rudder configured to control the direction of the entire wind powered UUV system 150 along with the actuators that can control the tension of the various cables coupled to the kite sub-system 152. As the UUV 158 is completely submerged, it does not encounter the harsher conditions of the surface of the water, generally improving the stability of the system, which is advantageous for the payload components such as cameras.

Whereas FIG. 1 illustrates a single ship 110 in communication with the wind powered UUV systems, certain embodiments may include multiple ships in communication with the one or more wind powered UUV systems. In a communications-deprived environment, for example when the satellite link is not available, multiple wind powered UUV systems may be deployed where the distance 170 may be large, e.g., 50 miles. In such situations, these systems can then act as relay stations establishing communication between vessels that may be quite far apart.

The example 100 illustrated by FIG. 1 also indicates that, while each wind-powered system may be unmanned, a central control station may exist, perhaps in the ship 110. From this central control station, each individual wind powered system, or a set of the deployed systems, or all of the deployed systems, may be commanded to accomplish a certain task or set of tasks such as providing surveillance around a specific target area. It will also be possible to deploy additional systems, e.g., to gain additional coverage area. Further, each wind powered system may be commanded to be mobile or remain “station-keep,” e.g., stay in the same location. Thus, it will be appreciated that the example 100 illustrated by FIG. 1 may offer significant flexibility and configurability of placement and location.

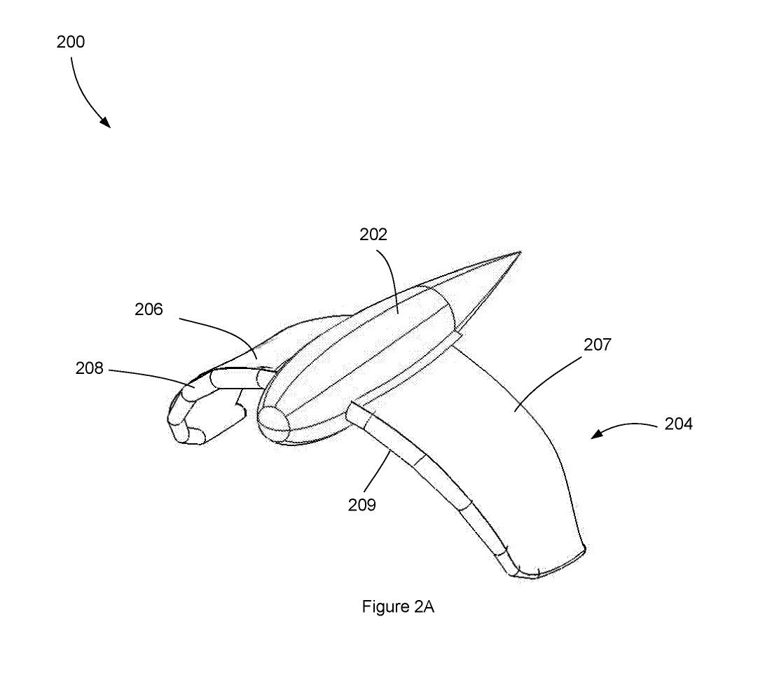

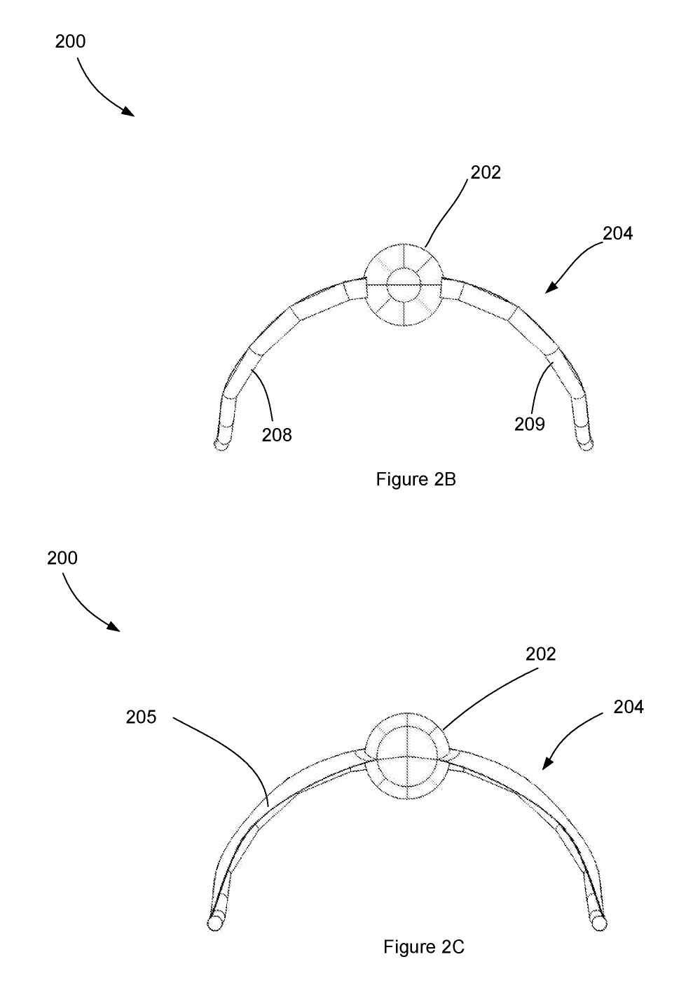

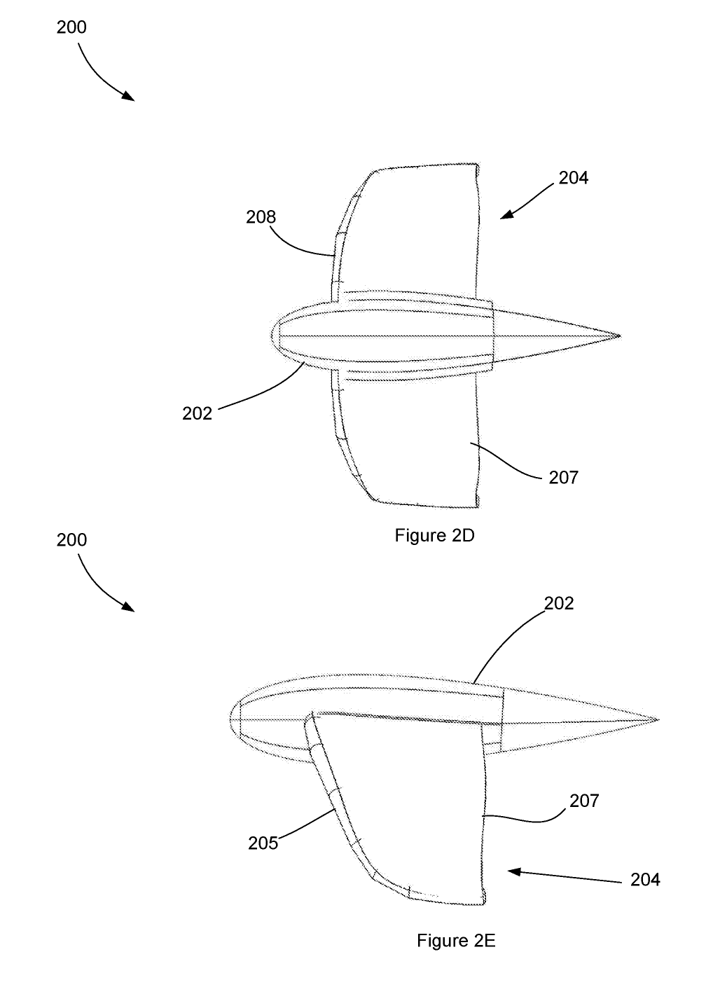

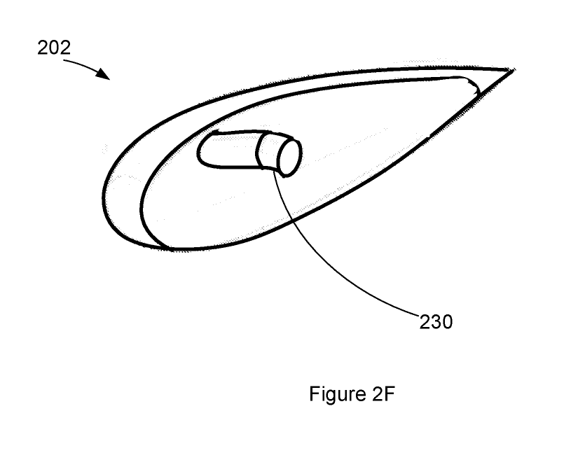

Several configurations of the kite sub-system 152 are possible. FIGS. 2A-E together illustrate a first embodiment 200 of a kite sub-system in accordance with the disclosed technology: FIG. 2A illustrates an isometric view of the first embodiment 200 whereas FIGS. 2B and 2C show the front and back views of the first embodiment 200, respectively. The top view of the first embodiment 200 is illustrated by FIG. 2D and the side view is illustrated by FIG. 2E.

The first embodiment 200 illustrated by FIGS. 2A-E includes a pontoon portion 202 and a kite portion 204 that includes two wings 206 and 207. The kite portion 204 may be a single fabricated piece of material extending on both sides of the pontoon and going through the pontoon to establish the two wings 206 and 207. Use of a single fabricated piece advantageously reduces the number of couplings and joints that are necessary to attach the wings 206 and 207 to the pontoon portion 202, thus minimizing the risk of structural failure at seams and joints, which become stressed as the kite sub-system rises in altitude. In alternate embodiments, the wings 206 and 207 may be separate components or assemblies, each coupled to either side of the pontoon portion 202. The pontoon portion 202 may be configured to provide the lighter-than-air capability to the kite sub-system whereas the kite portion 204 may be configured to provide the lift necessary to lift the entire kite sub-system to a desired elevation.

The pontoon portion 202 may be made of a fabric material having a high strength-to-weight ratio, which would advantageously reduce—and potentially minimize—the weight of the pontoon portion 202 itself. Examples of fabrics having a high strength-to-weight ratio include fabrics such as laminates of ultra-high molecular weight polyethylene (UHMWP), though other suitable fabrics are not excluded. These lightweight fabrics may be composed of flexible, multidirectional, non-woven laminates with oriented UHMWP filament layers and high performance films. An advantage of using such fibers is that the strength and modulus can be adjusted in virtually any direction by orienting fibers during the construction process. In addition to the fabric having a high strength-to-weight ratio, other desirable properties the fabric may possess include impermeability to the gas, e.g., helium, used to fill the pontoon portion 202 as well as rip and/or tear resistance. The permeability can be adjusted by the thickness and composition of the laminate films, for example.

To obtain the lighter-than-air property, the pontoon portion 202 may be filled with a suitable gas such as helium, ammonia, or hydrogen, for example. In designing the pontoon portion 202, an appropriate balance between the size, cost, maneuverability, and weight of the payload should be achieved. As an example, the cross-sectional area, and thus overall volume, of the pontoon portion 202 should be selected such that the kite sub-system may rise to a certain height in the air but not create excessive drag when the kite sub-system is flying through air. Because low drag is generally essential in being able to achieve high speeds, the size of the pontoon portion 202 should be kept small to limit the volume of displaced air. This in turn limits the maximum payload weight the kite sub-system can lift. Thus, to achieve low drag, the size of the pontoon portion 202 required to lift the necessary weight to a desired height should be kept as minimal as reasonable.

In certain configurations, the pontoon portion 202 may be designed to lift itself, a portion of the tether, and the kite portion 204 only as high as required to achieve a “fail-safe” height, e.g., the height at which the pontoon portion 202 may remain in the air even in zero wind conditions but having the payload float on the water. Specifically, the pontoon portion 202 might not be designed to lift the payload, ensuring that, in a zero-wind condition, the pontoon portion 202 remains in the air due to its lighter-than-air nature; however, when the wind velocity increases the kite portion 204, which is coupled to the pontoon portion 202, it creates the lift needed to elevate the kite sub-system and the payload to a greater height.

The internal pressure of the pontoon portion 202 also enables the fail-safe height concept. The pontoon portion 202 is typically filled with a lighter-than-air gas such as helium. The pontoon portion 202 is generally filled just enough to achieve the amount of pressure required to be able to achieve the fail-safe height, such as 0.5 lb-force per square inch gauge (psig). While ensuring a small volume, the low internal pressure also reduces the risk of structural failure at elevations as atmospheric pressure decreases with increased height, causing the pressure differential between the pontoon portion 202 and the atmosphere to increase, increasing the stress on the structure. Thus, low internal pressure is an advantageous configuration. A higher pressure, such as 5 to 10 psig, would provide a stiffer wing portion 204 and, thus, higher performance, but this would also result in greater stress on the joints.

The leading edges of the wings 206 and 207 of the kite portion 204 may each be coupled to an inflatable tubular balloon 208 and 209, respectively. In embodiments where the kite portion 204 is a single fabricated piece of material extending on both sides of the pontoon and going through the pontoon to establish the two wings 206 and 207, a single balloon may be implemented to establish the two inflatable tubular balloons 208 and 209. The function of the tubular balloons 208 and 209 is primarily to provide structural rigidity and maintain the shape of the kite portion 204 at higher elevations as well as reducing the number of bridle strings, e.g., strings to transmit tension from the kite controller to the kite (which helps maintain the shape of the kite), that may be needed if the tubular balloons 208 and 209 were absent. Because bridle strings add drag to the entire system, reducing the number of bridle strings may provide an advantageous configuration. The leading edge balloons 208 and 209 may be pressurized at much higher pressures, such as 10 psig, to maintain the shape of the kite portion 204 under load. The leading edge balloons 208 and 209 may be made of strong lightweight materials, for example.

The wings 206 and 207 may each be coupled to the top sides of the balloons 208 and 209, respectively, to preserve the aerodynamics of the kite. It may be advantageous to keep the radius of the cross-section of the tubular balloons 208 and 209 as small as possible to reduce the hoop stress experienced by the balloons 208 and 209 and also to reduce the drag contributed by the balloons 208 and 209. For a thin-walled cylinder, which each of the balloons 208 and 209 may be considered, the hoop stress is typically proportional to the product of the inflation pressure and the radius, so keeping the radius small generally enables higher inflation pressures given the same material. Consequently, using stronger materials may enable the use of higher pressures on a linear basis. That is, using material that is three times stronger may enable the use of three times higher pressures. Thus, implementation of the leading edge balloons 208 and 209 may yield a particularly advantageous configuration.

FIG. 2F illustrates a cross-sectional view of the pontoon portion 202 of the first embodiment 200 of an kite sub-system in accordance with the disclosed technology. In the example, the pontoon portion 202 includes a hollow structure that may be filled with a gas to keep it aloft. The pontoon portion 202 also includes a channel 230, which may go from side to side and through which the inflatable tubular balloons 208 and 209 may be passed through, e.g., in embodiments where a single balloon establishes the inflatable tubular balloons 208 and 209. The wing 115 may then be coupled to the tubular balloon and the side of the pontoon by using well-known techniques such as but limited to ultrasonic welding and stitching. In trying to choose an appropriate coupling method and coupling pattern, several factors such as but not limited to the internal pressure of the balloon and the operating height need to be considered in order to achieve reliability of design.

To achieve high maneuverability, the kite sub-system generally must be designed to go straight downwind and upwind and also station keep. Whereas many conventional systems using balloons are able to go downwind and may even be able to station keep in one location, going upwind or even at an angle to the wind is more challenging and provides a major advantage. The ability to go upwind or across the wind is related to the lift-to-drag ratio. Higher lift-to-drag ratios typically indicate increased capability to fly upwind or into the wind, as well as how fast the vessel may travel. Control of the kite is also required to go upwind. It is thus advantageous for the pontoon portion 202 to have a low drag, which may be achieved by having a small cross-sectional area, e.g., as noted above. The specification of only needing the pontoon portion 202 to rise to a fail-safe height advantageously aids in the achievement of low drag as the specification generally results in a design that uses a small cross-sectional area.

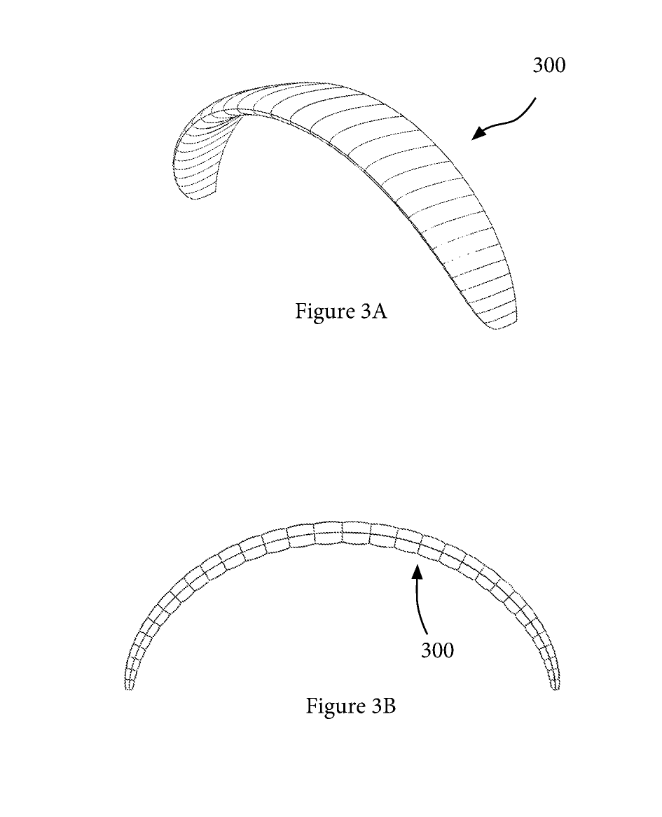

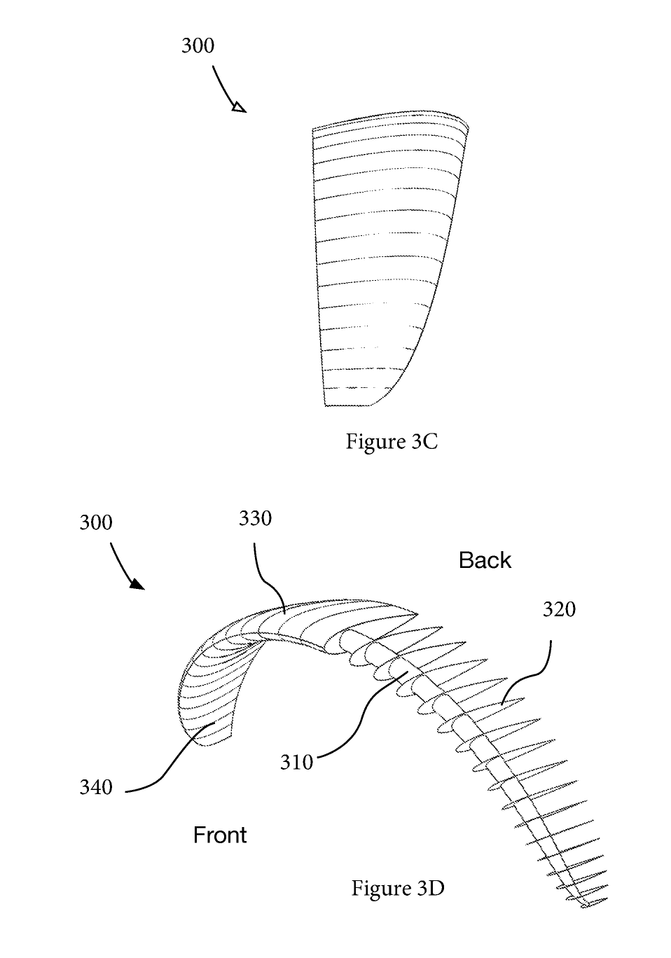

FIGS. 3A-D together illustrate a kite portion, e.g., a wing 300, of a second embodiment of a kite sub-system in accordance with the disclosed technology. This embodiment does not include a pontoon portion. The isometric view of this embodiment is shown in FIG. 3A, while the front view and the side view are shown in FIGS. 3B and 3C, respectively. This configuration, e.g., without the pontoon, generally reduces the frontal cross-sectional area compared to that of the configuration including the pontoon. Consequently, the drag is effectively reduced, thus making the kite sub-system more efficient. The drag associated with LTA volume is distributed into the wing 300 so all surfaces become wing or lifting surfaces. In this example, the LTA pontoon volume section is eliminated because it has no lifting surface.

The internal structure of this new configuration is illustrated by FIG. 3D where, on the right side of the figure, the outer skins are removed for clarity. In the example, the wing 300 may have an internal spar 310 that may be inflated to a high pressure, such as 3-15 psi, although other values are not excluded. The spar 310 may have a preformed shape so that, when it is inflated, its shape may be imposed on the wing 300. Alternatively, the spar 310 may not have a preformed shape but, rather, the shape illustrated by FIGS. 3A-C may be imposed by adjusting the tension of bridle strings (not shown). The spar 310, when inflated to the high pressures, generally imposes structural rigidity to the wing 300. While certain on-market kites locate a spar as an external component, thus exposing it to the wind which produces turbulent drag, these on-market devices design the kites in such a way that the wing surface is coupled to the top of the spar on the outside diameter. These design practices make the on-market kites inherently aerodynamically inefficient due to the presentation of the circular cross section at the leading edge of the kite in addition to the opportunity for turbulent conditions to exist behind the spar and below the wing. In contrast, as illustrated by FIG. 3D, the wing 300 locates the spar 310 as an internal component in the wing 300. Also, in a departure from on-market designs, the wing 300 may include two surfaces: a top surface 330 and a bottom surface 340. The spar 310 may be located within a cavity formed by the top surface 330 and the bottom surface 340 of the wing 300 as shown in FIG. 3D. The location of the spar 310 along with the double surfaced wing 300 may advantageously improve the aerodynamic property of the entire kite sub-system. The wing 300 and the spar 310 may both be made of lightweight but high-strength fabric such as, but not limited to, laminates using UHMWP. Yet another advantage of the high-pressure spar 310 is that fewer bridle lines are required to maintain the shape of the wing 300 which, consequently, leads to lower drag, simpler design, and more reliable deployment.

Referring back to FIG. 3D, multiple ribs 320 are shown coupled to the spar 310. The primary function of the ribs 320 is to hold the shape of the kite 300 from front to back. These ribs 320 may be made of the same lightweight but strong material, such as a strong fabric, as the wing 300. The ribs 320 may have a hole cut in each of them so that the spar 310 may pass through as illustrated by FIG. 3D. The ribs 320 may be coupled between the top surface 330 and the bottom surface 340 of the kite 300. Coupling may be accomplished by methods such as, but not limited to, gluing or taping. Methods such as gluing and taping, e.g., where no stitches are used, are generally advantageous as no extra thread material is added. Thus, the top surface 330 and the bottom surface 340 may form an enclosure within which the high-pressure spar 310 and ribs 320 may both be located. The space between the top surface 330 and the bottom surface 340 of the wing 300 may be inflated. In contrast to the high-pressure spar 310, this space may be inflated to a much lower pressure, such as 0.5 PSI, although other pressures are not excluded. To aid in pressure equalization throughout the inner space between the top surface 330 and the bottom surface 340, each rib 320 may have additional cuts or holes (not shown). Among the advantages provided due to the low pressure outside the spar 310 is that billowing, such as shown in FIG. 3B, may be reduced or even minimized Reducing the amount of billowing is generally advantageous because pronounced billowing typically contributes to increased drag and, thus, reduced aerodynamic properties.

In another aspect, the tips of the wing 300 may be vertical or almost vertical, e.g., between 70° and 90°, though other angles are not excluded. This design may be particularly advantageous because, when the kite is flying through air, the pressure on both sides of the wing tip may be equal or close to equal, which generally prevents turbulence forming at the wing tips. Because of the pressure difference between the top surface 330 and the bottom surface 340 at the wing tip of the wing 300, high pressure air from the bottom of the wing would generally flow toward the low pressure air at the top of the wing 300 and cause turbulence, resulting in reduced lift and increased drag. The vertical or nearly vertical wing tips illustrated in FIG. 3B would minimize or even eliminate this issue.

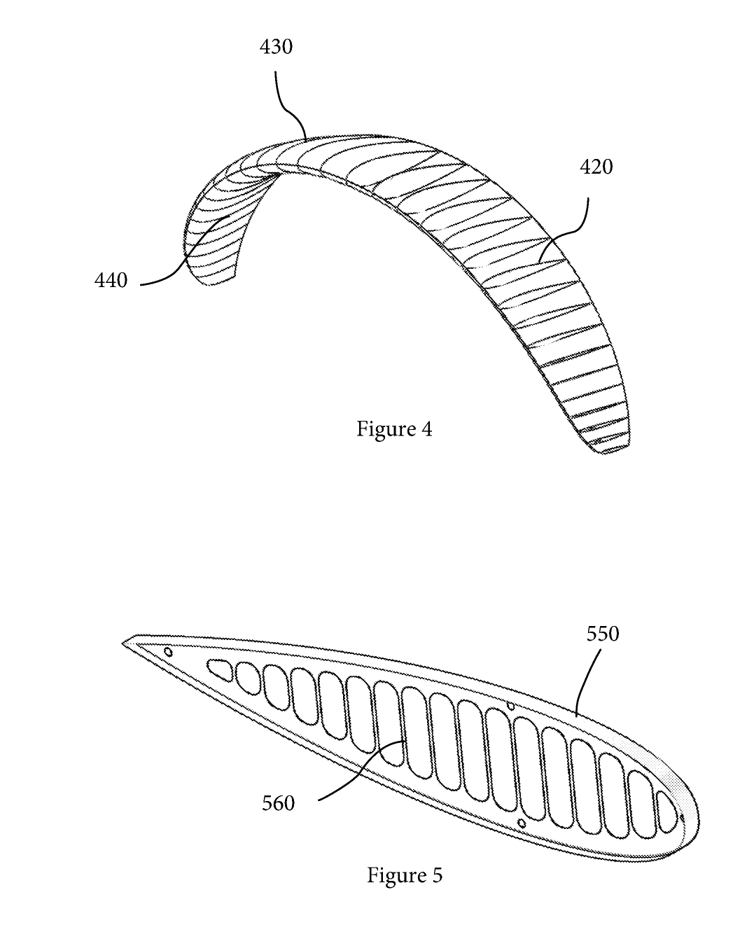

FIG. 4 illustrates an exemplary configuration of a kite sub-system that does not have a spar in accordance with the disclosed technology. In this configuration, there is no internal spar included but the kite may still be composed of a double-wing surface illustrated by top surface 430 and bottom surface 440 and may still have ribs 420. In the example, the ribs 420 do not have a hole for a spar. In this configuration, the entire kite may be inflated to various pressures ranging from just above ambient to as high as 10-15 psi, for example. Other pressures are not excluded. Among the advantages of this configuration is that, by pressurizing the internal volume between the wings, the stiffness and rigidity may be adjusted. Another advantage of this configuration is that the additional weight added by a high pressure spar is excluded, which consequently may result in the larger load carrying capacity of the kite. Thus, in some applications, the illustrated configuration of the kite without the spar may be preferred whereas, in other applications, a configuration of a kite with a spar, such as that illustrated by FIGS. 3A-D, may be preferred.

FIG. 5 illustrates an example of a rib such as the ribs 320 in the embodiment illustrated by FIGS. 3A-D and the ribs 420 in the configuration illustrated by FIG. 4. In certain embodiments, the rib body 560 may be composed of a web structure. The rib body 560 may be made of the same material as the wing, e.g., a light-weight but strong fabric such as laminates of UHMWPE. The web structure allows free gas flow, thus allowing the pressure to be equal on both sides of the rib. In certain embodiments, the rib body 560 may be coupled to a flange 550, which may be positioned perpendicularly to the rib body 560. In such a configuration, the flat surface of the flange 550 may be glued to the top and bottom wings on the inside surface of both wings. Coupling the ribs to the wings by gluing is particularly advantageous in that it generally eliminates any need to stitch the rib fabric and the wing fabric, which is significant because stitching typically adds material and, therefore, unnecessary weight.

In designing a kite sub-system such as the embodiments describe above, aspect ratio is one of the many parameters that determine how the kite operates. As used herein, aspect ratio is generally proportional to the square of the span length divided by the projected surface area. The aspect ratio may be altered by design for various different applications. As an example, the aspect ratio may be 3 for a low-speed, low-wind, and heavy-payload application. Alternatively, the aspect ratio may be 12-15 for a high-speed, light-payload implementation. Thus, depending on the implementation, the aspect ratio may be chosen appropriately.

In certain embodiments, the kite may be designed such that a specified weight of the payload may always be lifted by the kite buoyancy, including in zero-wind situations. This concept may be applied to designs and configurations with and without pontoons. As indicated above, the aspect ratio may be adjusted to achieve different load carrying capabilities, e.g., in zero wind. Various design parameters may be adjusted to achieve various load carrying capabilities for the kite configuration, e.g., in zero wind situations.

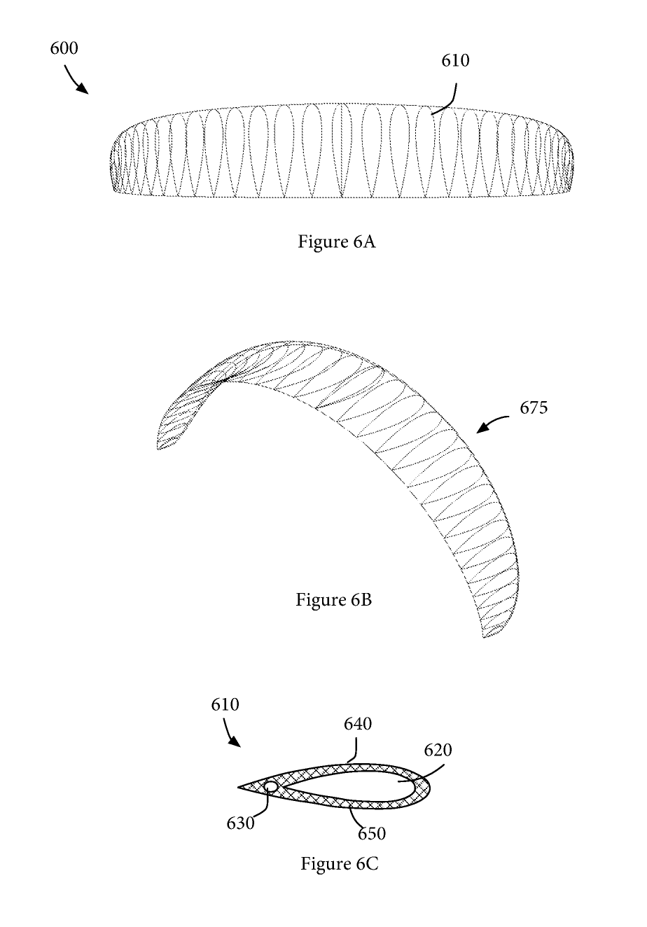

FIGS. 6A-C together illustrate a first embodiment 600 of a kite having bladders 610 in accordance with the disclosed technology. FIG. 6A illustrates a top view of the embodiment 600 and FIGS. 6B and 6C illustrate isometric and cross-sectional views, respectively. The configuration 600 illustrated by FIGS. 6A-C advantageously prevents kite collapse and altitude drop if leaks occur during a mission. One or multiple bladders 610 initially filled with helium or other suitable lighter-than-air gas may be placed inside the compartments made by the top, bottom and two sides of the ribs. Several methods to couple the internal bladders 610 may be used. FIG. 6C illustrates the cross-section of a bladder 610 where the cross-hatched section may be coupled to the interior of top and bottom surface of the wing. Thus, a first surface 640 may be coupled to the interior of the top wing surface and a second surface 650 may be coupled to the interior of the bottom wing surface. A space 620 may be utilized for the lighter-than-air gas and a hole 630 may provide for the free passage of air within the interior space of the wing. Thus, the bladder 610 is typically only coupled along a strip of its surface at the top and bottom while the other regions of the bladder 610 are free to expand and contract depending on the pressure inside it. Thus, if the bladder 610 deflates completely, the sections that are coupled to the interior surfaces of the wing still provide support as ribs. In certain alternative configurations, a side-wall of the bladder may be coupled along strips to the inside surface of the top and bottom wing surface. Thus, this side-wall behaves as a rib and is free to expand and contract in the interior space of the wing, depending on the pressure inside the bladder. Thus, if the bladder deflates, its functionality as a rib remains intact.

In addition to the various shapes and coupling methods of the bladder, the number of bladders may be varied, which provides the advantage that, if one or multiple bladders fail, the lighter-than-air property may be preserved due to other intact bladders. With such configurations, one or multiple valves may be coupled to the wing to provide a passageway between the internal space of the wing and the ambient air. These valves may be located along the wing in the front. An example location of one of the valves is illustrated in FIG. 6B by arrow 675. Specifically, these valves may be held closed by the inflated bladders pressing against the wing surface. If a leak develops and a bladder or bladders deflate, the valve or valves may open and fill in the internal space in the wing with ambient air. In an extreme situation, if all of the bladders were to leak, the kite would lose its lighter-than-air property but it would still be airborne as it would function as a normal ram-air kite. Thus, these configurations may prevent altitude collapse and, thus, prolong mission time.

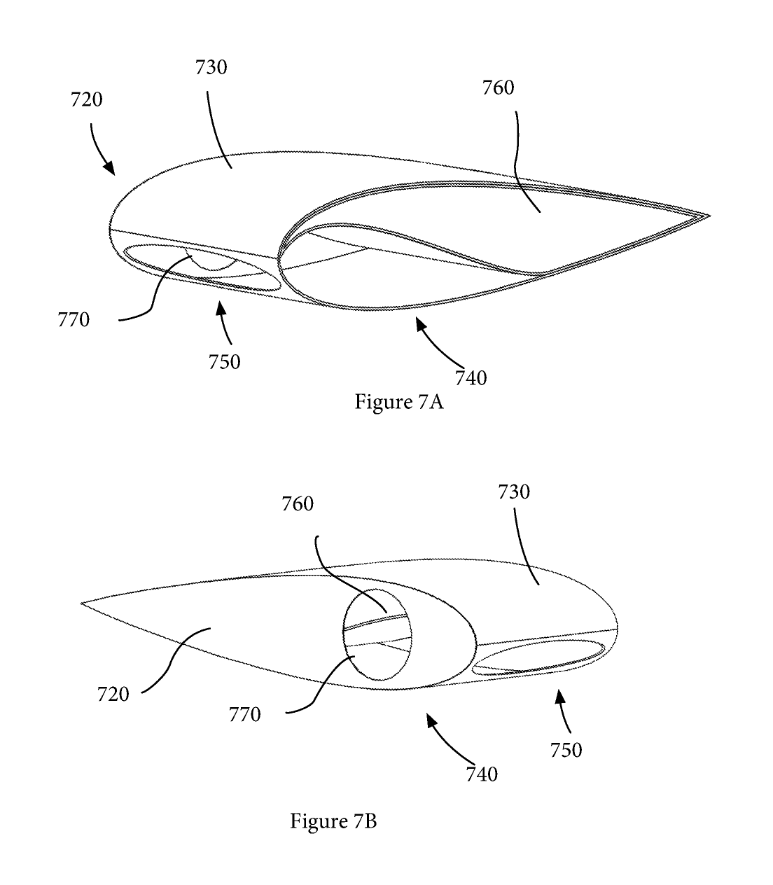

FIG. 7A illustrates a first view of a second embodiment of a kite having bladders in accordance with the disclosed technology. FIG. 7B illustrates a second view of the second embodiment of a kite having bladders. In the example, a section of the wing between the ribs is shown. A single rib 720 is shown while the adjacent rib is not, for clarity of explanation. In the example, the rib 720 has a hole 770 whose function will be explained below. The top and bottom surfaces of the wing are labeled as 730 and 740, respectively. The space between ribs may be filled with a lighter-than-air gas, such as helium. However, in such a configuration, one or multiple sections between the ribs may contain bladders such as bladder 760. Considering just one section of the wing between a pair of ribs, a bladder may be coupled in various advantageous locations within the wing, e.g., coupled to the wing at the leading edge of the wing, on the inside surface of the wing. In addition to a bladder, the location of a ram air intake valve is shown by 750. The intake valves provide a pathway for ambient air to get into the space between the ribs but not escape. In operation, initially the bladders may be filled with a lighter-than-air gas and then expand and assume the shape of the wing sections. The pressure exerted by the bladders on the intake valves may keep the valves closed but, as the helium escapes, e.g., when the kite is airborne and is moving, the ram air intake valve may open as the pressure within the bladder would diminish and ambient air may then flow into the space between the ribs. The pressure of the air inside the space between the ribs would push the bladder against the surfaces of the wing and, as more helium escapes from the bladder, more air is let into the space and the bladder would collapse further. As the process continues, most or all of the helium may escape and the space between the ribs may become filled with air. In situations where multiple bladders exist, each bladder may lose helium at its own rate. The pressure due to the ambient air getting into the wing space may be then equalized due to the holes 770 in the ribs 720. During this process, the kite loses its lighter-than-air property and assumes the characteristics of a ram air kite.

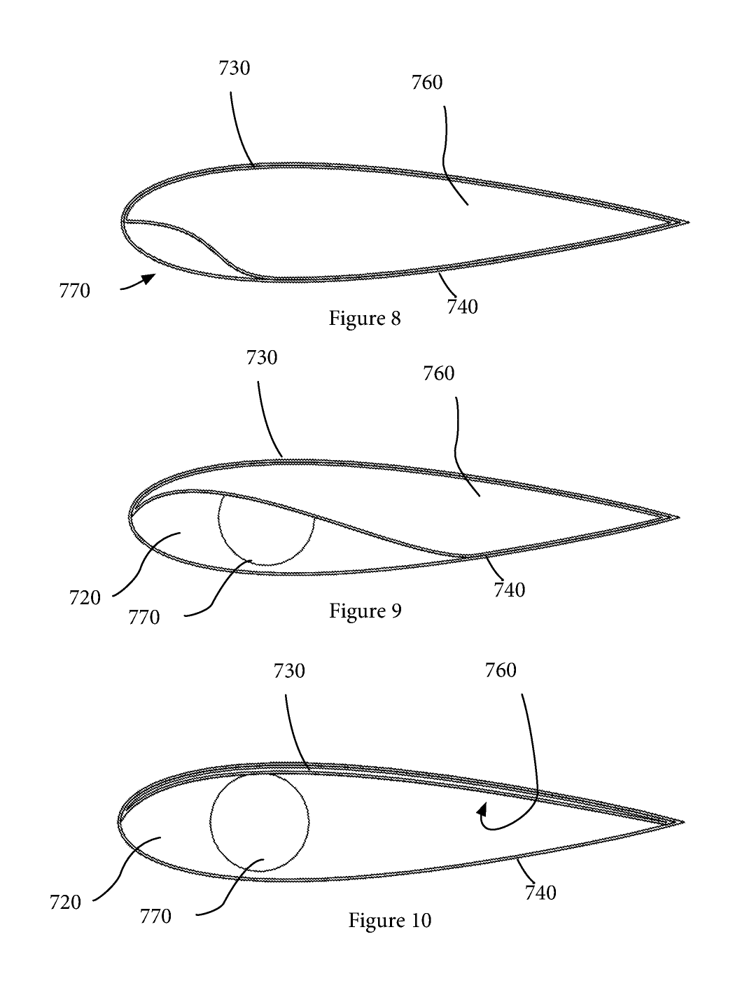

FIGS. 8-10 illustrate the collapse of the bladder 760 and intake of ambient air in accordance with certain embodiments of the disclosed technology. FIG. 8 illustrates a first stage of the collapse of the bladder 760 and intake of ambient air, and FIGS. 9 and 10 illustrate second and third stages thereof, respectively. FIGS. 8-10 show a side view of the bladder 760 and a rib, e.g., behind the bladder 760. FIG. 8 shows the bladder 760 almost inflated. It should be noted that the cross section of a fully inflated bladder would be identical to the shape of the cross section of the wing. As the helium escapes, the bladder 760 collapses and more air is let in, as shown by FIG. 9. In FIG. 10, the helium is mostly gone and the bladder 760 is pushed back against the inside surface of the wing. It is to be noted that, whereas these figures show the bladder 760 coupled to the leading edge of the wing, other coupling locations are possible. Thus, this transition from a lighter-than-air kite to a kite that has the characteristics of a ram air kit ensures that the kite does not collapse when the lighter-than-air gas escapes.

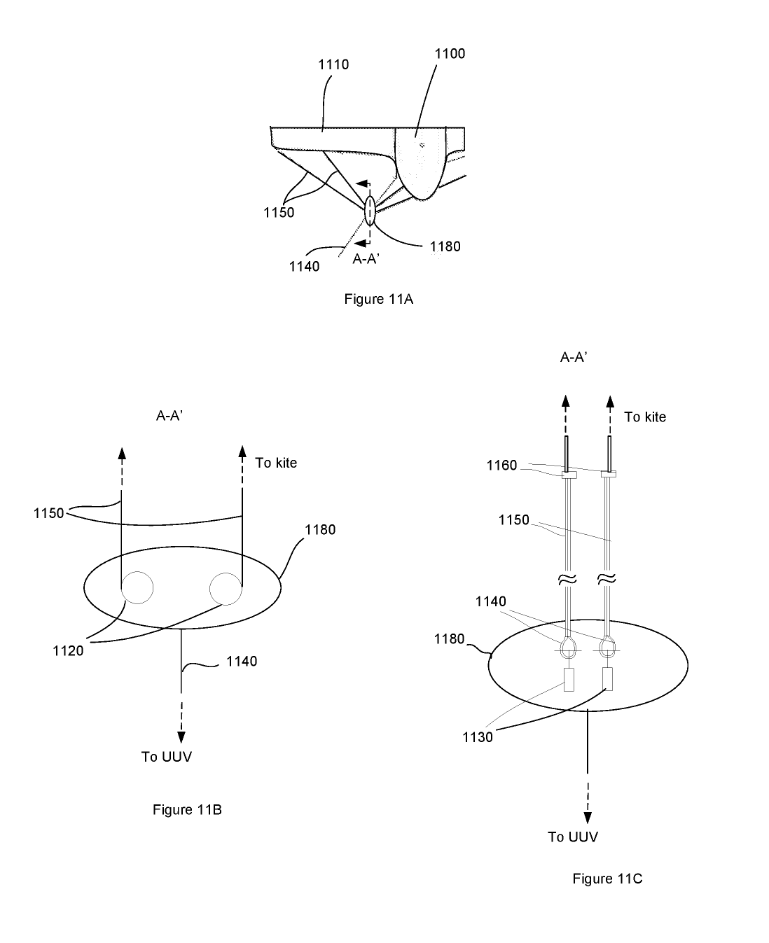

The control pod and payload platform may be combined into a single physical entity (see, e.g., control pod and payload platform 154 of FIG. 1) or it may be kept as two or more separate entities. For example, the control pod may be one entity and the payload platform may be made up of one or multiple entities. Referring to the control pod, its primary function is to provide a mechanical structure to house motors or actuators with which bridle strings that couple the control pod to the wings of the kite, may be controlled. FIGS. 11A-C together provide an illustration of an example of such a control pod in accordance with certain embodiments of the disclosed technology.

FIG. 11A illustrates a section of an exemplary kite sub-system having bridle strings 1190 and a control pod 1180, from a top view. Section A-A′ shown in FIG. 11A is shown in more detail in FIGS. 11B-C. The control pod 1180 may house motors or actuators that control the tension of the bridle strings 1190. Each of the bridle strings 1190 may be coupled to its own motor or actuator. Various different lightweight motors or actuators are commonly available which may be utilized for this purpose. FIG. 11B illustrates a cross-sectional view of the control pod of the exemplary kite sub-system. In the example, two motors 1120 may be coupled to reel drums, which may provide a mechanism for the bridle strings 1190 to wind around, thus increasing the tension. When a tension decrease is required, the motor or actuator may be commanded to unwind the bridle string. Thus, by controlling the tension of each bridle string separately, the shape of the kite may be controlled.

FIG. 11C illustrates the use of twisted strings 1150 for use as bridle strings in the exemplary kite sub-system. Various types of twisted strings are available and may be utilized as bridle strings. In the example, each twisted string is shown to be composed of a single string doubled back on itself with a loop 1140 on one end. The free ends of the twisted string 1150 may be terminated by a termination block 1160 which holds the ends of the string in a fixed position while the rest of the string may be twisted upon itself. The termination block 1160 may be coupled to the wings of the kite and may obtain its ability to prevent the ends of the twisted string from twisting upon itself from the structure of the wing. For example, the termination block 1160 may be composed of metal reinforced eyelets or holes built into the structure of the wing, thus providing a location for the end of the string to be tied to the wing. On the other side of the twisted string within the control pod, the string may make a loop shown as 1140. Motors or actuators 1130 may be coupled to the loop so that the loop may be twisted, enabling the string to be twisted upon itself. Thus, by twisting, the tension on the twisted string may be increased; this tension can be transmitted to the wing, thereby enabling the ability to change the shape of the wing. The kite may be thus controlled using such mechanisms.

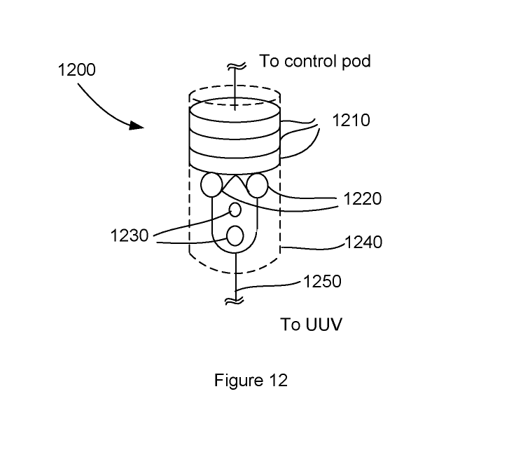

FIG. 12 illustrates an example of a payload platform 1200 in accordance with the disclosed technology. The payload platform 1200 is typically a mechanical structure configured to allow the mounting of various modules thereon, including but not limited to communication modules, camera modules, control modules and decoy modules. The platform 1200 is generally configurable, e.g., so that the types and number of modules mounted on each deployed UUV system may be customized as per the objectives of each mission. FIG. 12 illustrates one such configuration. Modules 1210 may consist of communication modules including but not limited to satellite communication modules, geo-positioning modules, radar modules, radio modules, power supply modules, computer modules and signal processing and image processing modules. Modules 1220 may represent antennas that may be mounted on the platform. Cameras such as infra-red cameras, visible light cameras may be mounted and are represented by 1230. Although not explicitly shown, the payload platform 1200 may contain additional sensors including but not limited to position sensors (e.g., GPS and inertial measurement units), velocity sensors, temperature sensors, and air pressure sensors.

As the payload platform 1200 may float on the water, e.g., at times when there is no wind, the payload platform 1200 may be contained in a watertight container 1240. The shape of the payload platform 1200 may be such that, when the payload platform 1200 is in water, flotation thereof is ensured. The watertight container 1240 may be made of various light-weight materials such as plastic or polyurethane, for example. It also may be transparent so that visible light cameras may be housed within it. With the general mechanical structure of the payload platform 1200 now described, the following paragraphs describe the types of capabilities that the payload platform 1200 may have.

The communications subsystem may be capable of any of a number of different communication modes, such as communications with a remote operation control center (e.g., housed on a ship), inter-kite communications, and communications with a base station (e.g., a satellite). In order to maintain uptime of the kite-powered UUV system, the physical hardware providing these communication capabilities may be advantageously lightweight. The communication modules may be designed to be electrically efficient and use very little power, thus enabling the use of smaller batteries, longer life, or power generation systems.

In certain embodiments, the payload platform 1200 may also carry further intelligence gathering modules and/or surveillance modules, e.g., including the electronic intelligence (ELINT) module and the visual intelligence (VISINT) module. As the names indicate, these modules may advantageously provide electronic intelligence and visual intelligence in a military environment.

As indicated above, the payload may contain signal processing and image processing modules. In certain embodiments, the amount of data that is transmitted from the payload platform 1200 may be minimized In certain embodiments, the images from the one or multiple cameras may be fed into an image analyzer resident within the computing module in the payload platform 1200. The images may be analyzed for moving objects, e.g., enemy ships, in a background that may also contain other moving objects, e.g., waves or shadows. In this example, when a ship is detected, an image may be transmitted. If no ships are detected, however, images of the ocean may not be transmitted. In other embodiments, the images from the cameras may be processed and, instead of sending the entire image, only part of the image may be transmitted. The selection of the sub-image may be made by the image-processing module, e.g., based on programmable rules.

In other embodiments, some or all the modules may be turned off when the payload platform falls below a certain height. For example, if the payload platform 1200 is floating on water, the cameras may be turned off and then turned on again when the payload platform regains a certain minimum height. In such embodiments, the payload platform 1200 may have an altimeter that always measures the height and is always powered on. When the payload platform 1200 falls below a certain height, a switch coupled to the altimeter may turn off some or all the electronic systems, such as the cameras. This type of capability may advantageously extend the battery life as well as the ability of the vehicular system to be operational for a longer duration.

Consequently, a network of one or multiple payload platforms located at a certain height, for example at 2,500 feet, may advantageously provide significant intelligence, surveillance, and communication capabilities.

The tether may couple the kite system to the UUV. In addition to providing the mechanical coupling, the tether may also provide a mechanical structure to route electrical wiring from the UUV to the payload platform and control pod. The electrical wiring may be on the inside of a waterproof insulator providing extra mechanical structure to the tether. The insulator may be made of materials that have high strength to weight ratio, and the electrical wiring may consist of coaxial twisted pair conductor. In addition to providing electrical energy to the various modules and the control pod, these same wires may be used to send data and communication signals between the UUV and modules within the payload platform. This technique may reduce or even eliminate any need for separate electrical wires for power and for data and signal communication.

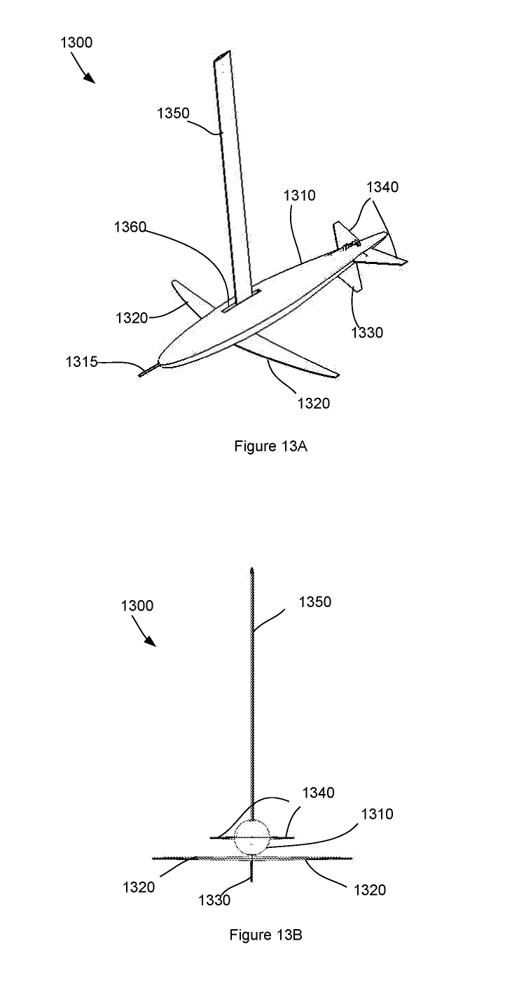

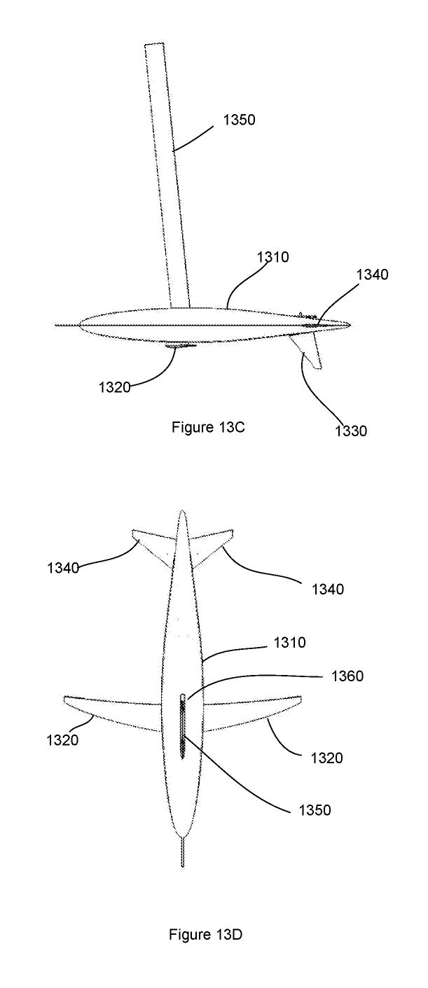

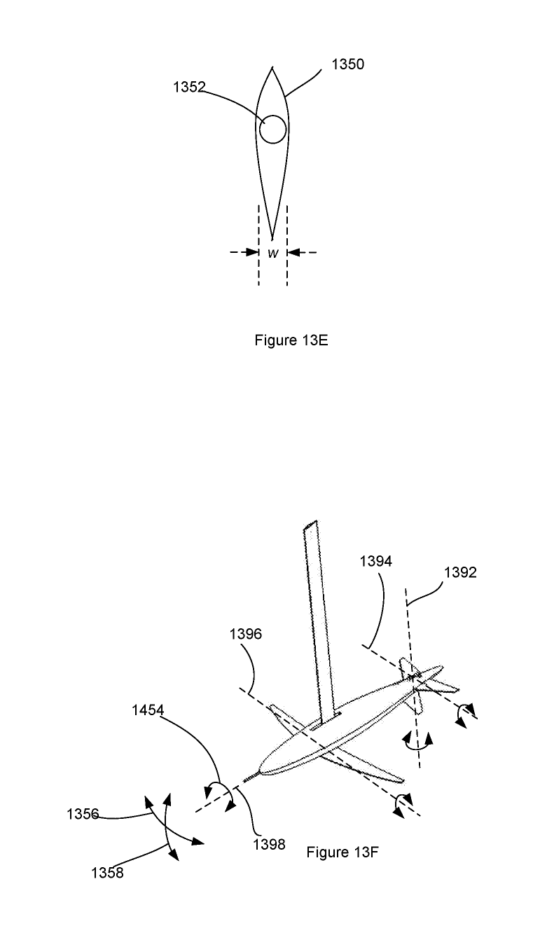

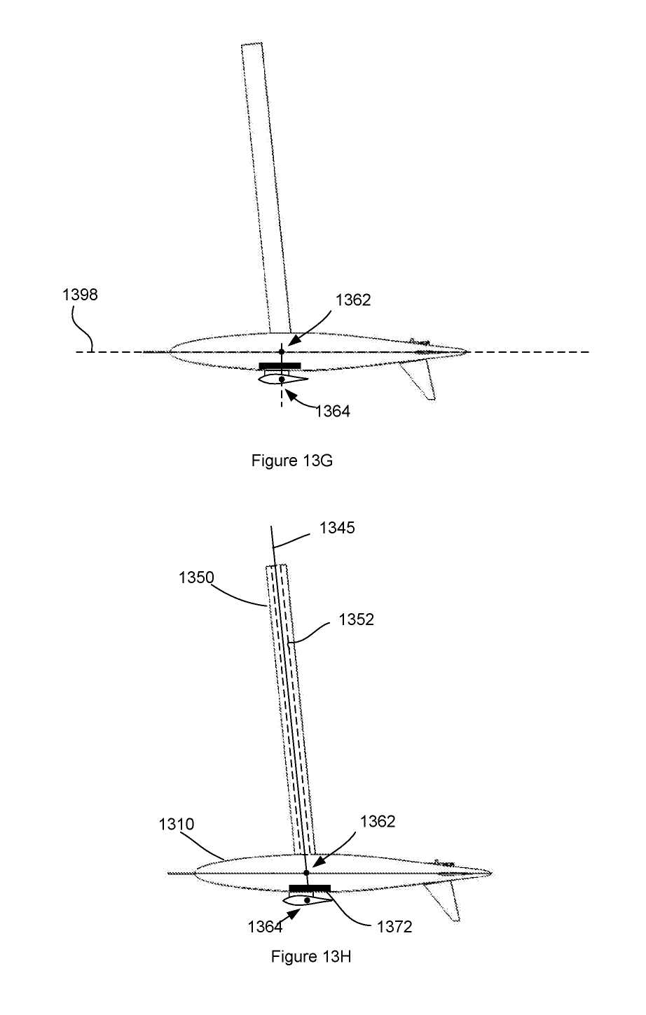

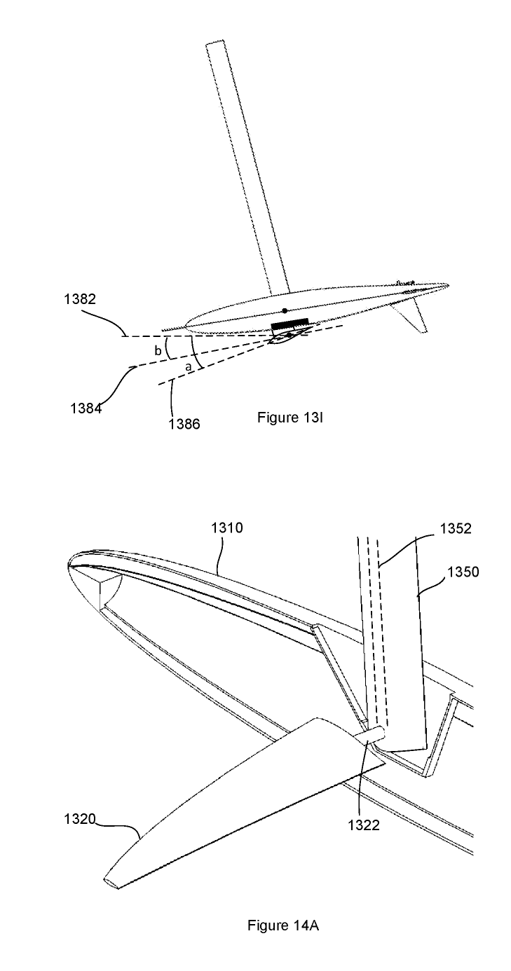

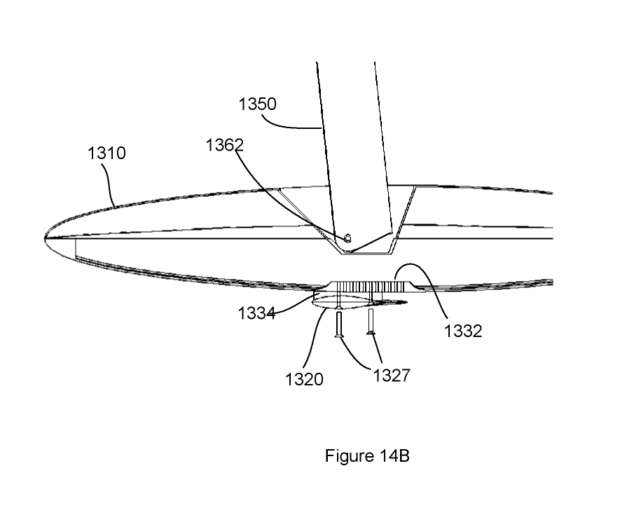

FIGS. 13A-I together illustrate an example of a submerged UUV 1370 in accordance with the disclosed technology, such as the submerged UUV 158 illustrated by FIG. 1. FIG. 13A provides an isometric view of the submerged UUV 1370 whereas FIGS. 13B, 13C, and 13D provide front, side, and top views of the submerged UUV 1370, respectively. The external features of the UUV 1370 generally include a hull 1310, a pair of wings 1320, a pair of elevators 1340, a rudder 1330, a pitot tube 1315, a mast 1350, and a slot 1360 inside of which the mast 1350 may pivot forward and aft. In certain configurations, the wings 1320 may be placed below the UUV 1370. In certain other configurations, the wings 1320 may be placed on the side of the UUV 1370.

The UUV 1370 may have one or several control surfaces. As used herein, a control surface generally refers to a surface that may be articulated to affect the physical state of the UUV 1370 including but not limited to heading, depth, and velocity. Thus, control surfaces may include the wings 1320, the elevators 1340 and the rudder 1330. Alternatively, a ring-tail design may be used in place of the elevators and rudders, leveraging advantages in ring-tails including efficiency and removal of tip vortices, which increase drag. It is not necessary, however, for all of these surfaces to be control surfaces. For example, a fixed wing may be used instead of a controlled wing. Alternatively, more surfaces may be included as control surfaces. For example, the entire wing may be a controlled surface but the wing may be composed of sub-members that may be separately controllable with respect to the wing. Furthermore, control surfaces may be added forward of the wings, not just aft of the wing.

In the example, the mast 1350 is a long structure able to pivot about fixtures within the hull. Among other functions, it may provide a routing mechanism for the tether that also gets coupled to the hull. To minimize the drag, the mast 1350 may have a symmetrical hydrodynamic profile where the top view of the mast is shown, as illustrated by FIG. 13E. Minimizing the width w minimizes the frontal cross-sectional area, thus minimizing the drag. The mast 1350 may also be eliminated, very short, or be internal to or just external of the UUV. In this case, a faring over the tether would be used to reduce drag.

FIG. 14A illustrates an example of the wing support structure to which the wings 1320 and the mast 1350 may be coupled. More specifically, FIG. 14B illustrates how the mast 1350 may be coupled to the hull 1310. This figure shows a cross section of the hull 1310 along a plane containing the longitudinal axis 1398 (see, e.g., FIG. 13H) and also illustrates how the forward wing 1320 may be attached and articulate to change angle-of-attack (AoA). In the example, the wing support structure 1322 that couples the wing 1320 to the hull 1310 for the configuration when the wing 1320 is located at the side of the hull 1310, is visible. It should be noted that such concepts may also apply to alternative configurations in which the wing is below the hull.

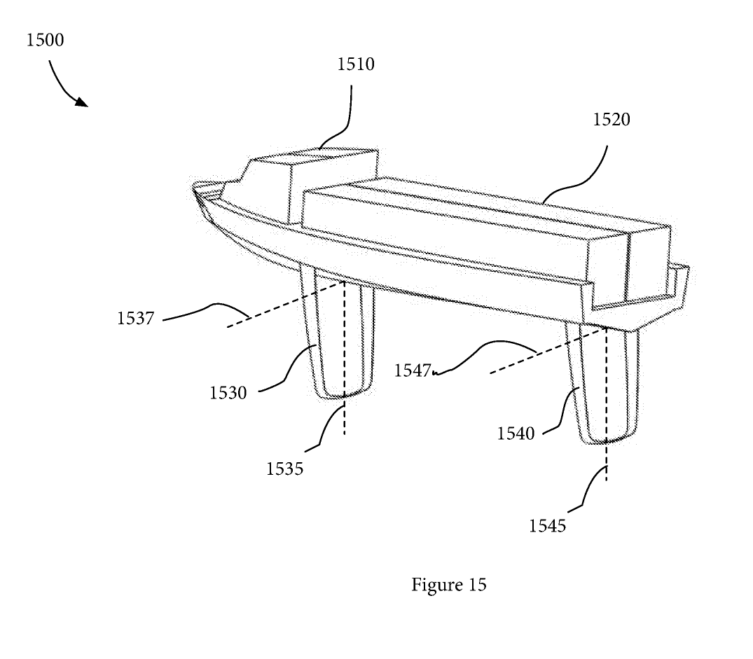

In the example, the wing support structure is seen as a cylindrical rod going through the hull 1310, though other shapes and configurations are possible. As shown in FIG. 15A, the mast 1350 may also be coupled to the same wing structure such that the mast 1350 may pivot about the structure. Thus, by coupling the mast 1350 and the wing 1320 to the same support structure, the mast 1350 and the wing 1320 are not able to roll in relation to each other, thus ensuring perpendicularity of these two members. The roll plane is indicated by arrow 1354 in FIG. 13F.

In the example illustrated by FIG. 14A, the figure also shows a conduit 1352 (shown in dashed lines) going through the length of the mast 1350 such that the tether which runs through this conduit may be coupled to the wing support structure 422. This arrangement may ensure that, when there is tension on the tether, e.g., due to the kite, and the tether direction changes generally to the left or the right of the hull, the wings 1320 may stay perpendicular to the tether. The perpendicularity occurs because, at the point where the tether exits the mast 1350, since the mast 1350 and the UUV 1370 are able to rotate freely in water, a fulcrum is created. The mast direction becomes aligned to the tether direction and, since the mast and the hull cannot roll with respect to each other and since the wings 1320 are perpendicular to the mast 1350, the wings 1320 become perpendicular to the tether.

As noted above, the wings 1320 may either be a fixed structure with respect to the hull 1310 or it may be actuated, thus making it a control surface. Also noted above, parts of the wing 1320 may also be actuated independent of the entire wing being actuated, similar to control surfaces on an aircraft wing. The lift experienced by the UUV 1370 can be controlled by the design, placement, and angle-of-attack of the wing.

FIG. 14B illustrates an example of the capability to adjust the angle of incidence of the wing 1320 and its longitudinal placement along the hull 1310. More specifically, the example illustrates some of the angular parameters that need to be considered while designing the wing 1320 and coupling the wing 1320 to the hull 1310. While the figure shows the wings 1320 below the hull 1310, it will be appreciated that these concepts may also be applied to embodiments in which wings are placed on the side of the hull. In the example, dashed line 1382 represents the horizon, dashed line 1384 is a line parallel to the longitudinal axis of the hull and dashed line 1386 represents the chord line (e.g., a straight line between the leading edge and the trailing edge) of the wing 1320. The angle between the chord line 1386 and the longitudinal axis 1384 may be called the incident angle of the wing 1320. The angle between the horizon (i.e., line 1382) and the longitudinal axis (i.e., line 1384) of the hull 1310 may be called the angle of attack of the hull 1310. As the UUV 1370 glides through the water, the incidence angle of the wing 1320 is so chosen such that the flow of water around the wing 1320 creates a negative lift (i.e., a lift in the downward direction). This negative lift may be required to counter balance the positive lift (i.e., lift in the upward direction) that the kite may impose on the UUV 1370.

In contrast to typical fixed wing systems, the incidence angle of the wing 1320 may be controlled even while the UUV is in motion. The angle of attack may be altered by changing the angle of incidence of the wing 1320, thereby affecting the dynamic and static state of the UUV 1370 including but not limited to heading, depth, velocity, and the drag experienced by the body 1370. In a wing 1320 on the side of the hull 1310 configuration, motors or actuators may be coupled to the wing support structure 1322 and may be able to rotate the structure affecting the incident angle. Some parts of the mechanism to change the incident angle when the wing 1320 is below the hull 1310 are described below.

In FIG. 14B, a cross section of the hull 1310 is illustrated along with the pivoting mast 1350. In the example, the wing 1320 is placed below the hull 1310. In this case, the body of the hull 1310 itself may provide the wing support structure in addition to providing a support for the pivot of the mast 1350. The pivot point is shown by 1362 in the figure. A cylindrical rod such as 1322 in FIG. 15A may be inserted through a hole in the mast at the location 1362 and secured to the body of the hull 1310. The wing 1320 may be coupled to the bottom of the hull 1310 by threaded bolts 1327, which may be inserted into holes in the wing 1320 and may screw into matching threaded holes 1332 in the hull 1310, which may have multiple threaded holes, e.g., to provide the ability to adjust the position the wing 1320 along the hull 1310. In order to accommodate the contours of the wing 1320 and the hull 1310, a compressible material 1334, e.g., made of a material such as Ethylene Vinyl Acetate (EVA), may be placed between the top surface of the wing 1320 and the bottom surface of the hull 1310. The compressibility of the material 1334 may advantageously provide the ability to accommodate the varying contour of the hull 1310 as the wing position 1320 is chosen along the hull 1310.

In addition to the ability to choose the location of the wing 1320 along the hull 1310, the incidence angle of the wing 1320 may be altered by loosening or tightening the bolts that couple the wing to the hull 1310. In the example, the bolts are arranged in a longitudinal plane, one towards the front and one towards the back of the hull 1310. By loosening or tightening each bolt individually, the angle of incidence of the wing 1320 may be altered. This angle may be altered manually during set up time or when the hull 1310 is out of the water, or it may be altered automatically if motors or actuators were to be included in the hull 1310 and coupled to the bolts so that the tension of the bolts can be altered.

The angle of attack of the hull 1310 may also be controllable via the elevator, which may be pivotable about an axis 1394 illustrated by FIG. 13F, and may be perpendicular to the longitudinal axis of the hull 1310, extending out through the elevator. Rotation of the elevator about this axis may rotate the UUV 1370 in the pitch plane in the direction shown by arrow 1358 in FIG. 13F, thereby adjusting the angle of attack of the wing 1320 and the hull 1310, which influences the amount of lift the UUV 1370 experiences. If the wing 1320 is not articulable, the increased angle of attack of the wing 1320 and the hull 1310 increases the frontal cross-sectional area that the UUV 1370 presents to the water, which then consequently increases the drag. It is thus advantageous to be able to control the angle of incidence of the wing 1320 with respect to the hull 1310 so that the frontal cross-sectional area presented by the entire UUV 1370 may be minimized in addition to being able to control the lift.

Yet another advantage may be obtained by controlling the angle of attack. That is, by varying this parameter, the upward force experienced by the UUV 1370 due to the tether may be counterbalanced by the downward force provided by the mechanisms of the UUV 1370 discussed above. By controlling the angle of attack, in addition to counterbalancing the upward force, the depth of the UUV 1370 may be controlled. Thus, in certain embodiments, the angle of attack may be adjusted automatically as a function of the tether angle or as a function of the tension experienced by the tether. In configurations where the tether is routed through the mast 1350, the angle of the tether may be obtained my measuring the angle of the mast 1350. Other techniques may be used to measure the angle of the tether by coupling sensors to the tether. The angle information may be input into the control system of the vehicle, for example. Similarly, the tension experienced by the tether may also be measured and input into the control system of the vehicle. Thus, with such capabilities, the varying force due to the varying angle of the tether may be accommodated.

Another control surface may be provided by the rudder, which may pivot about the axis 1392 illustrated in FIG. 13F. It is generally advantageous to place the rudder on the bottom of the hull 1310 rather than the top in order to avoid reducing the effectiveness of the rudder as a control surface, which may happen due to the interference created by the flow pattern of the water downstream of the mast 1350 as the UUV 1370 glides through the water. The rudder my control the angle of the UUV 1370 in the yaw direction, as indicated by the arrow 1356 in FIG. 13F, for example. If the rudder were placed on the top of the hull 1310, although the yaw angle of the UUV 1370 may change if the rudder direction is altered, the direction of motion may not be controllable due to the flow pattern behind the mast 1350. To avoid this issue, the rudder may be placed on the bottom of the hull 1310 and the effectiveness of the rudder may be maintained. The mast 1350 may then provide a fulcrum point about which the UUV 1370 can yaw due to the influence of the rudder. With such an advantageous configuration, the heading or the steering direction of the UUV 1370 can be controlled.

In certain embodiments, the various centers of mass or lift and the control points, such as fulcrums, may be aligned. As an example, the wing structure 1322 may be placed such that the pivot point of the mast 1350 about the wing structure may occur vertically above the center of lift of the wing 1320, as illustrated by FIG. 13G (where the location of the pivot of the mast 1350 is shown as 4162 and the center of lift of the wing 1320 is shown as 1364). In addition, the center of mass of the hull 1310 may occur in the same plane containing the center of lift of the wing 1364 and the mast pivot point 1362. In fact, the center of mass of the hull 1310 may be coincident with the mast pivot point 1362. By aligning these centers as above, better control of the UUV 1370 may be achieved. Having each of these center of efforts adjustable also provides a convienty way of balancing the various forces, including kite pull, hydrodynamic wing force, drag, pitching moments of the aft control surfaces, etc. As an example, when the UUV 1370 is at rest, the alignment described above may ensure that the UUV 1370 is horizontal in the water, ready to glide through the water instantaneously when needed. If the mast 1350 did not pivot, then the UUV 1370 may assume angles to the horizon as dictated by the wind as the tether is coupled to the UUV through the conduit in the mast 1350. Not only would these angles not be zero relative to the horizon, they may change quite rapidly due to rapidly changing wind directions and the UUV 1370 would not be able to glide fast or efficiently in water under these circumstances. The ability of the mast 1350 to pivot thus enables the UUV 1370 to be generally horizontal as the tension of the tether is translated to the mast 1350, affecting its own pivot angle with respect to the hull 1310.

In certain embodiments, the length of the mast or faring over the tether 1350 may be selected based on at least on two criteria. The first criterion may be that the length of the mast 1350 should be minimized, e.g., to ensure minimal drag. As the length of the mast or faring 1350 increases, the UUV 1370 may submerge deeper in the water and encounter much greater drag. However, a second criterion may require that the mast 1350 be as long as required to ensure that the UUV 1370 is deep enough that the wing tips never emerge out of the water. If the wing tips come out of the water, the UUV 1370 may stall and become difficult to operate. Wing tips may emerge out of the water, for example, when the kite is low on the horizon and to the side of the UUV 1370 so that the UUV 1370 is tilted in a plane perpendicular to the longitudinal axis (e.g., when the UUV has rolled along its roll axis). To ensure that the wing tips do not come out of the water, the mast 1350 may need to be at least as long as the wing span (twice as long in certain embodiments). In other words, the length of the mast 1350 may be chosen so that, below a certain roll angle, the wing tips do not come out of the water.

A similar explanation may be used to determine the length of the slot 1360 in which the mast 1350 pivots. The length of this slot 1360 may be used to limit the pivot angle. If the length is too short, then the wind may tilt the UUV 1370 in its longitudinal plane against which may cause some parts of the UUV 1370 to come out of the water. However, in this situation, only practical considerations typically limit the length of the slot 1360 and the pivot angle. Thus, the pivot angle may be limited to +/−45°. For very short masts, and where a faring is used, higher angels forward and aft of the pivot are achievable.

FIG. 15 illustrates an example of a UUV 1500 having hydrodynamic foils 1530 and 1540 in accordance with certain embodiments of the disclosed technology. In the example, these foils 1530 and 1540 are coupled at the bottom to the UUV 1500. The foils 1530 and 1540 may have a hydrodynamic shape so that, as the UUV 1500 moves forward, an upward lift may be created which elevates the above water components and thus reduces the drag the UUV experiences. Further, the foils 1530 and 1540 may have one or multiple control surfaces that may provide the ability to control the depth and the direction of the UUV 1500. Additionally, the foils 1530 and 1540 may have the ability to rotate about a vertical axis or a horizontal axis. In the example, the vertical axis and the horizontal axis of foil 1530 are illustrated by 1535 and 1537 respectively. Similarly, the vertical axis and the horizontal axis of foil 1540 are illustrated by 1545 and 1547 respectively. Rotation about other axes is not necessarily excluded. FIG. 15 also shows compartments 1510 and 1520, which may be used to transport people or goods or both. The tether (not shown in FIG. 15) may be coupled to the UUV 1500 at various locations. The tether and the kite have the same functionality as described previously. Thus, as the kite pulls the UUV 1500, the hydrodynamic foils 1530 and 1540 may lift the UUV, which may reduce the drag. Thus, high speeds (e.g., in excess of 45 mph) may be obtained by such a configuration.

In alternative embodiments, the length of the mast may be minimized, e.g., through the use of fairing or a foil shaped covering over the tether. As described above, the mast may provide a conduit for the tether, however, it contributes to the total weight and drag of the UUV. The tether may be routed so that it comes out the top of the mast. In such configurations, the mast length may be reduced, and the portion of the tether between where it exits the mast and where it exits the water, may be covered by a fairing or some other covering, e.g., made of a lightweight material and having a hydrodynamic shape. This combination of a shorter mast and a tether enclosed within a fairing for some portion of its length may advantageously reduce drag, e.g., compared to configurations including a longer mast and in which no fairings are implemented.

In certain embodiments, a buoyancy engine may be included within the UUV. Such embodiments may advantageously enable diving maneuvers to be accomplished at high speed or low speed, followed by periods of very slow to zero motion due to ocean current drift only so that sensors may encounter quiet environments required by towed sonar arrays that may be coupled to the UUV.

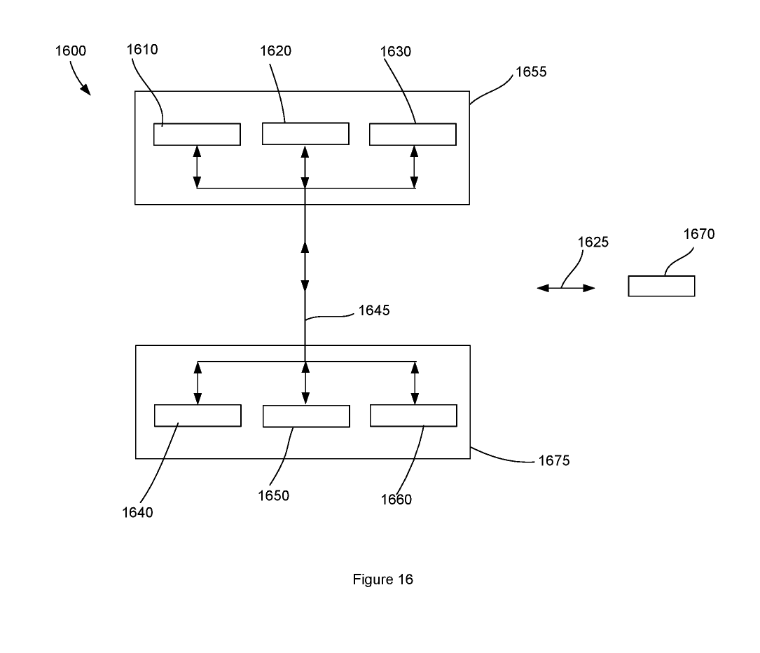

FIG. 16 illustrates an example of a control system for a kite-powered UUV system 1600 in accordance with certain embodiments of the disclosed technology. In general, the control system consists of sensors, computers, actuators and communication mechanisms. The members of the control system may be located both on a kite system 1655 and/or on a UUV 1675. In the example, the kite system 1655 may have one or more sensors 1610, a computer 1620, and one or more actuators 1630. Similarly, the UUV 1675 may also have one or more sensors 1640, a computer 1650, and one or more actuators 1660.

FIG. 16 also shows a control station 1670 that may communicate wirelessly to the members on the kite system 1655 and on the UUV 1675. This wireless communication is depicted generally by 1625. Several variations of the configuration shown in the figure are possible including but not limited to having only one computer, which may be located in the UUV 1675. FIG. 16 depicts that data including but not limited to sensor data and control data may be passed back and forth between the components in the kite system 1655 and the components in the UUV 1675. As an example, the air velocity measured by an anemometer may be measured by the sensors in the kite system 1655 and that data may be passed to the computer in the UUV 1675 which may then act upon this data and command a different attack angle. As another example, a wind vane may sense the direction of the wind and send this information to the computer in both the kite system 1655 and to the computer in the UUV 1675. These two computers may then command the actuators in the kite system 1655 and the actuators in the UUV 1675 to control the trim of the kite 1655 and the UUV 1675, however, these actions may be coordinated so that the kite 1655 and the UUV 1675 may act together.

In certain embodiments, the cameras on board the payload platform can feed the images to the control system, and the control system may act upon this data. For example, if the camera and the image processing capability associated with the camera system detects an obstacle such as a log floating in the water, it may inform the control system, which may then act upon this information and change the heading of the kite and the UUV to avoid the log by commanding the actuators. After the log is avoided, the control system can command the resumption of the original course. Such action can occur locally within the vehicular system, without any human intervention. In other words, the vehicular system can act fully autonomously.

Other embodiments may include the coordinated activity of multiple vehicular systems. For example, if the cameras from any one or multiple vehicular systems detect an oil slick floating on water, the set of vehicular systems in danger of going through the oil slick can be commanded to steer clear of the oil slick. These commands may be generated by an external agent, or each vehicle can determine itself autonomously what its path should be while coordinating its dynamic state with other vehicles. In such embodiments, each vehicular system is thus able to determine its own static or dynamic state individually or in coordination with other vehicular systems deployed in the same environment.

In other examples, waypoints can be provided to the system, and the control algorithm can determine the best way to reach the waypoint, such as tacking up wind until reaching the desired location, or going further in one direction because of an observed improvement in the wind conditions in that particular direction, such as a direction further from shore, which is commonly the case.

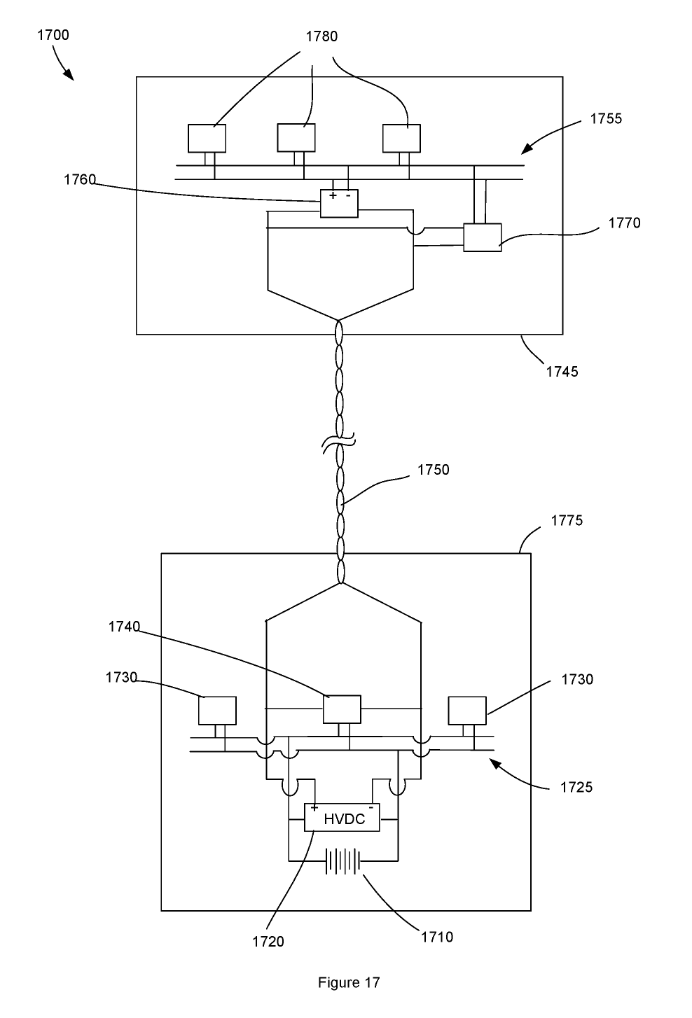

FIG. 17 illustrates an example of an electrical sub-system in accordance with certain embodiments of the disclosed technology. A power source, such as a battery or a rechargeable battery, may be located in a UUV 1775. Since power sources tend to be heavy, by locating it in the UUV 1775, the kite system 1745 does not need to lift it. The power source in the UUV 1775 is indicated by battery 1710, which is connected to a high voltage direct current (HVDC) transformer in order to transmit power to the kite system 1745. This transformer may step up the voltage of the battery to 500 Volts, for example. Other voltages are not excluded. This high voltage may then be transmitted via twisted pair conductors 1750 to the kite system 1745. The subsystems within the UUV 1775 that may need power including but not limited to sensors, communication equipment, and actuators are indicated generally by 1730 in the figure. These subsystems may be powered directly by the batteries 1710. These subsystems may be connected to an electrical bus 1725, which may distribute power within the UUV 1775. On the kite system 1745, a step down transformer or a DC-DC converter 1760 may transform the high voltage to voltages more appropriate for powering the local subsystems. As in the UUV 1775, the subsystems in the kite system 1745 that may need electrical power include but are not limited to sensors, communication equipment, and actuators. These subsystems are indicated by reference number 1780 in the figure and are shown to be coupled to an electrical bus 1755, which may be used to distribute power.

Although the illustrated examples includes a configuration in which the power source is located in the UUV 1775, other configurations, such as locating a power source (which may be a generation source) elsewhere including but not limited to in the payload are not excluded.

In certain embodiments, to avoid making the tether thicker than it needs to be, only the minimum number of conductors between the kite system 1745 and the UUV 1775 may be used. The figure shows a twisted pair of conductors 1750 providing the electrical circuit between the battery HVDC supply in UUV 1775 and the DC-DC converted in the kite system 1745. This twisted pair 1750 forms part of the tether, however, the same twisted pair 1750 may be used for sending data and signals as well. In fact, a twisted pair 1750 may be used only to support the ability to send data and signals, as a twisted pair is not necessarily needed to just transfer DC power. The data may need to be conditioned before it is transferred through the twisted pair conductors 1750. On the UUV 1775, member 1740 may perform the data conditioning through modulation. On the kite system 1745, member 1770 may perform the demodulation such that the data components of the high voltage signal are isolated. Thus using this technique, additional conductors for data may not be needed.

In certain embodiments, the batteries may be rechargeable. In certain embodiments, the UUV system may be powered by wind. One or multiple propellers may be attached to the UUV and operated backwards so that, as the UUV glides through the water, it turns the propellers and power may be generated and fed back into the batteries. Such a configuration may extend the duration of deployment of the vehicular systems. For the UUV with propellers, calculations indicate that, at 25 mph, 1200 watts of mechanical energy may be converted to 600 watts of electrical energy, and then transmitted 2.5 km up a tether to a payload, where line losses (i.e., resistive losses) may provide 500 watts at the elevated payload. The mechanical energy lost may amount to about 30 pounds of force pulled out of the system in the forward direction, which at 25 mph for a 25m2 kite in 15 mph winds would be less than a 2% loss in speed.

In certain embodiments, one or multiple antennas may be integrated or suspended by various sections of the kite system. For example, a long dipole antenna may be integrated within the tether. Alternatively, a patterned antenna may be integrated within the structure of the wings of the kite. For example, a loop antenna may be integrated within the circular kite illustrate by FIGS. 6A-D. Most of energy emanating from such a loop antenna may point skyward, thereby allowing its use with near-vertical incidence radio propagation in the HF (i.e., 1.8 to 10 MHz) band. In such configurations, radios signals may be transmitted upward to bounce off the ionosphere and re-radiate into a pattern such that the signal covers an expanded area extending to an approximately 500 km radius from the origin (i.e. kite). Other antenna designs may also be supported depending on the shape of the wing. Wing shapes such as those illustrated by FIGS. 3A-D and 4 may support antenna designs for use with UHF (i.e., 300-400 MHz band). Lower frequency (e.g., LF and VLF) dipole antennas can be incorporated into the tether to support very long range communications (e.g., greater than 4,000 km). Also, higher frequency microwave bands (e.g., X, K, Ka) can be received using conformal antenna arrays laminated to the outer surfaces of the kite's wing.

Implementations of the kite system described above may operate in any of a number of different modes, such as motion of multiple vehicular systems as a group. As mentioned above, each vehicle or multiple vehicles can be commandeered to fly as desired either under unmanned control, under manual control, or a combination of both. As an example of such advantageous flexibility, each vehicle or multiple vehicles can be commandeered to fly in a pattern called “dip and sprint,” in which the one or multiple kite-powered UUVs would drive fast to a designated location and, while at a proscribed location, loiter to allow the UUV to dive below in the ocean's surface layer. The kite may then be allowed to remain still above the water line. These types of motions may be very useful for anti-submarine warfare applications where sensitive underwater sonar equipment located onboard the UUV may be turned on. The ability to dive deep is particularly advantageous in this case. In other applications, sets of two vehicles may be arranged to realize a bi-static sonar configuration. Even further other sonar configurations are possible, such as providing a sound source only, etc.

Implementations of the systems described herein may be used in a number of commercial and non-commercial applications. For example, such systems may be used for the transportation of goods. Further examples may include using such systems for electricity generation. For example, the kites may be tethered to a body that may be made to move on a track. As the kite is powered by wind, it imparts motion to the body, and such motion may be harnessed to produce electricity.

Having described and illustrated the principles of the invention with reference to illustrated embodiments, it will be recognized that the illustrated embodiments may be modified in arrangement and detail without departing from such principles of this new sailing vessel, and may be combined in any desired manner And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A wind-powered unmanned underwater vehicle (UUV) system, comprising:
a kite sub-system configured to be powered by wind energy;
a control pod coupled with the kite sub-system and configured to control the kite sub-system;
a payload platform configured to provide a mechanical structure on which at least one module may be mounted;
a submersible UUV; and
a coupling device configured to physically couple between the kite sub-system and the submersible UUV.

2. (canceled)

3. (canceled)

4. The wind-powered UUV system of claim 1, further comprising an electrical sub-system that includes:
a power source located within the submersible UUV;
a first electrical bus within the submersible UUV and configured to deliver power from the power source to components within the submersible UUV;
a second electrical bus within the kite sub-system and configured to deliver power from the power source to components within the kite sub-system; and
electrical lines electrically coupled between the first and second electrical buses.

5. (canceled)

6. The wind-powered UUV system of claim 1, wherein the kite sub-system includes a pontoon and a plurality of wings, and wherein each of the plurality of wings is coupled to a tubular gas-filled balloon on its leading edge.

7. The wind-powered UUV system of claim 6, wherein a pressure inside the tubular balloon is higher that a pressure within the pontoon.

8. The wind-powered UUV system of claim 1, wherein the kite sub-system includes a pontoon and a plurality of wings, and wherein the control pod includes at least one device to control a tension of bridle strings that couple the at least one device to the plurality of wings.

9. The wind-powered UUV system of claim 8, wherein the at least one device includes a motor, an actuator, or both a motor and an actuator.

10. (canceled)

11. The wind-powered UUV system of claim 1, wherein the kite sub-system includes a double-surface wing, and wherein the double-surface wing includes a high pressure spar located inside an enclosure formed by the double surface wing.

12. (canceled)

13. The wind-powered UUV system of claim 1, wherein the kite sub-system includes a closed loop kite system, and wherein the closed loop kite system includes two kites coupled to each other, and further wherein one of the kites is inverted with respect to the other kite.

14. (canceled)

15. (canceled)

16. The wind-powered UUV system of claim 4, wherein the coupling device is further configured to provide a conduit for the electrical lines.

17. The wind-powered UUV system of claim 4, wherein the electrical lines may be configured to transfer data, control signals, or both data and control signals between the submersible towable body and the kite sub-system.

18. The wind-powered UUV system of claim 1, wherein the submersible towable body includes:
a hull;
a mast configured to pivot about a center of mass of the hull; and
controllable wings coupled with the mast and configured to create a negative lift.

19. The wind-powered UUV system of claim 18, wherein the mast has a symmetrical hydrodynamic profile.

20. The wind-powered UUV system of claim 18, wherein the mast includes a conduit for the coupling device.

21. The wind-powered UUV system of claim 1, wherein the submersible towable body includes control surfaces configured to control a direction of the wind-powered UUV system.

22. The wind-powered UUV system of claim 1, wherein the submersible towable body includes one or more propellers configured to be driven backwards as the wind-powered UUV system glides through water.

23. (canceled)

24. The wind-powered UUV system of claim 4, wherein at least a portion of the electrical sub-system is configured to automatically turn off responsive to the kite sub-system falling below a certain height.

25. (canceled)

26. The wind-powered UUV system of claim 1, wherein the kite sub-system includes a pontoon and a plurality of wings, the system further comprising at least one antenna integrated within the plurality of wings.

27. (canceled)

28. The wind-powered UUV system of claim 1, wherein the kite sub-system includes at least one internal bladder configured to be initially inflated with a gas, and wherein the kite sub-system further includes at least one valve configured to open when the gas leaks.

29. A wind-powered unmanned underwater vehicle (UUV) system, comprising:
a kite sub-system configured to be powered by wind energy;
a control pod coupled with the kite sub-system and configured to control the kite sub-system;
a payload platform configured to provide a mechanical structure on which at least one module may be mounted;
a towable unmanned underwater vehicle (UUV);
a hydrofoil coupled with the towable UUV and configured to prevent the towable UUV from being completely submersed in water; and
a coupling device configured to physically couple between the kite sub-system and the towable UUV.

30. A system, comprising:
a first wind-powered unmanned underwater vehicle (UUV) system including:
a first kite sub-system configured to be powered by wind energy;
a first control pod coupled with the first kite sub-system and configured to control the first kite sub-system;
a first towable UUV; and
a first coupling device configured to physically couple between the first kite sub-system and the first towable UUV; and
a second wind-powered UUV system including:
a second kite sub-system configured to be powered by wind energy;
a second control pod coupled with the second kite sub-system and configured to control the second kite sub-system;
a second towable UUV; and
a second coupling device configured to physically couple between the second kite sub-system and the second towable UUV, wherein each of the first and second control pods is configured to communicate with the other.

31. The system of claim 30, wherein the first and second control pods are further configured to create an ad-hoc communications network between the first and second wind-powered UUV systems.

32. The system of claim 31, wherein the ad-hoc communications network extends to at least one satellite.

33. The system of claim 31, further comprising:
a third wind-powered UUV system including:
a third kite sub-system configured to be powered by wind energy;
a third control pod coupled with the third kite sub-system and configured to control the third kite sub-system;
a third towable UUV; and
a third coupling device configured to physically couple between the third kite sub-system and the third towable UUV, wherein each of the first, second, and third control pods is configured to communicate with each of the other control pods.

34. (canceled)

35. (canceled)
